(19) United States
(12) Patent Application Publication
(10) Pub. No.: US 2026/0279084 A1
(43) Pub. Date: Sep. 17, 2026

(54) SYSTEMS AND METHODS FOR LANDMARKING DURING FINGERPRINTING AND AUTHENTICATION OF PHYSICAL OBJECTS

(71) Applicant: Peggy Inc., Toronto (CA)

(72) Inventors: Adam Meghji, Toronto (CA); Craig Follett, Toronto (CA)

(73) Assignee: Peggy Inc., Toronto, ON (CA)

(21) Appl. No.: 19/168,696

(22) PCT Filed: Mar. 25, 2024
(86) PCT No.: PCT/CA2024/050369

§ 371 Date: Sep. 24, 2025

Related U.S. Application Data
(60) Provisional application No. 63/454,513, filed on Mar. 24, 2023.

(51) Int. Cl. G06V 20/00; G06T 11/00; G06V 10/10; G06V 10/25; G06V 10/75; G06V 20/20; G06V 20/80

(52) U.S. Cl. CPC G06V 20/95; G06T 11/00; G06V 10/10; G06V 10/25; G06V 10/757; G06V 20/20; G06V 20/80

(57) ABSTRACT

Disclosed herein are systems and methods for landmarking during fingerprinting and authentication of physical objects.

### CROSS-REFERENCE TO RELATED APPLICATION

This application claims priority to United States Provisional Patent Application Ser. No. 63/454,513 filed on Mar. 24, 2023, the contents of which are incorporated herein by reference.

### FIELD OF THE INVENTION

The following relates generally to authentication of physical artifacts such as artwork, and particularly to processes and systems for automatically authenticating physical artifacts using digital image capture and processing, which may be used for the creation or maintenance, of non-fungible tokens (NFTs), registries, registrations, or the like, that may uniquely represent physical artifacts or a specific fractionalized region or regions of such physical artifacts.

### BACKGROUND OF THE INVENTION

Authentication of original physical artifacts, such as original artworks, can present a challenging problem. An original physical artifact regarded as valuable is particularly susceptible to counterfeiting. It can be extremely difficult, however, particularly for a non-expert or any casual observer, to distinguish a high quality counterfeit physical artifact from an original physical artifact of which it is a copy.

Where an original physical artifact has a sufficiently high value, the opinion of an expert may be sought by a potential buyer and/or other stakeholders to confirm its authenticity. The buyer and any other stakeholders may thereby be assured that it is indeed the original physical artifact. Such an expert may have historical knowledge of the provenance of the original physical artifact, may have once studied the actual original physical artifact in person, and may have other skills and/or knowledge to aid the authentication process and to provide stakeholders with a confirmation of authenticity.

Retaining an expert can be expensive and time-consuming. This may be justifiable and important for cases of high-value and/or historically-important transactions of physical artifacts. However, this may not be justifiable in other cases. To address the problem of authenticating physical artifacts in other cases, a printed certificate of authenticity may accompany or be affixed to an original physical artifact to help assure a buyer that the physical artifact being purchased is authentic. While a certificate of authenticity may provide sufficient assurance in certain cases, it can itself be easy to counterfeit.

United States Patent Application Publication No. 2023/0094557 to Meghji et al. (“Meghji at al.”), the contents of which are incorporated herein by reference, discloses methods and systems for authentication of physical objects through capture and processing of fingerprint data through digital artifacts. Meghji et al. propose using digital imaging by a mobile computing device to capture particular information about a physical artifact. Such information may be used for various purposes, including for the creation of a digital fingerprint of the physical artifact itself, and/or for use in determining whether the physical artifact can be successfully authenticated against a digital fingerprint of an original physical artifact that had been previously produced. Methods and systems described by Meghji et al. may be useful for enabling non-expert, casual, or any other person or system to determine whether a particular physical artifact in their presence is itself the same as, or different from, a physical artifact to which a particular previously-generated unique digital fingerprint pertains. Methods and systems described by Meghji et al. may be used to enable such people to confidently assure themselves that a physical artifact in their presence is genuine and/or is the physical artifact they believe it to be. In embodiments, Meghji et al. describe a method including capturing, by a device, a current digital image of a region of interest containing a physical artifact. The method includes presenting, by the device, an instruction to capture a next digital image of a segment of the region of interest, the instruction comprising a graphical indication of the segment generated based on the current digital image. Meghji et al. further describes that the segment of the region of interest to be captured may be defined based on a hotspot identified in the current digital image, with the hotspot being a high entropy area in the current digital image. Such methods may be conducted as part of a process of generating a unique digital fingerprint of the physical artifact that is within the region of interest, thereby to enable subsequent authentication of the physical artifact. Furthermore, such methods may be conducted to determine whether a physical artifact within a region of interest can be matched with a previously-generated unique digital fingerprint of the physical artifact, thereby to authenticate the physical artifact.

The Meghji et al. systems and methods are quite effective. However, improvements that can further aid a user using the mobile device with the task of locating the segment of the region of interest so that it may be approached for a next digital image capture, are desirable.

### SUMMARY OF THE INVENTION

In accordance with an aspect, there is provided a method comprising: (a) capturing, by an imaging system of a computing device, a current still image of a region of interest; (b) receiving, at the computing device, location data that defines a location within the current still image of a segment of the current still image, the location data generated based on an identification of a hotspot within the current still image; (c) generating, by the computing device based at least on the location data and the current still image, a reference image corresponding to the segment; (d) capturing, by the imaging system of the computing device, an incoming video stream containing frame images; and (e) during the capturing of the incoming video stream: displaying, by the computing device on a display screen, the frame images of the incoming video stream; and for each frame image of a plurality of the frame images of the incoming video stream: responsive to a determination, by the computing device, that a portion of the frame image has at least a threshold amount of content correlation with the reference image, generating, by the computing device, a graphical indication demarcating the portion of the frame image; and displaying, by the computing device on the display screen with the frame images of the incoming video stream being displayed, an overlay containing the graphical indication.

In embodiments, step (e) comprises: for each frame image of a plurality of the frame images of the incoming video stream: responsive to a determination, by the computing device, that no portion of the frame image has at least the threshold amount of content correlation with the reference image, displaying, by the computing device with the frame images of the incoming video stream, the overlay without the graphical indication.

In embodiments, step (e) comprises: responsive to the determination, by the computing device, that the portion of the frame image has at least the threshold amount of content correlation with the reference image and a further determination that the portion is at least a threshold proportion of the frame image, at least one of: automatically capturing, by the imaging system of a computing device, a next still image of the region of interest; and instructing a user of the computing device to cause the imaging system of the computing device to capture the next still image of the region of interest.

In embodiments, instructing the user of the computing device to cause the imaging system of the computing device to capture the next still image of the region of interest comprises changing a visible characteristic of the graphical indication demarcating the portion of the frame image.

In embodiments, the method comprises, responsive to a capture of the next still image, conducting (b), (c), (d), and (e) with the next still image as the current still image.

In embodiments, the method comprises processing the reference image to extract reference image keypoints; wherein the determination, by the computing device, that the portion of the frame image has at least the threshold amount of content correlation with the reference image comprises: processing the frame image to extract frame image keypoints; determining one or more matches between the reference image keypoints and the frame image keypoints; generating a mapping of the reference image to the frame image based at least on the one or more matches; calculating an amount of overlap between the reference image and the frame image based on the mapping; and determining that the amount of overlap meets or exceeds a threshold amount of overlap.

In accordance with another aspect, there is provided a system, comprising: a computing device having an imaging system and executing a front-end component of an application, the front-end component of the application being in communication with a back-end component of the application executing on a server, the front-end component of the application configured to: (a) cause capture, by the imaging system, of a current still image of a region of interest; (b) receive, from the back-end component, location data that defines a location within the current still image of a segment of the current still image, the location data generated by the back-end component based on an identification of a hotspot within the current still image; (c) generate, based at least on the location data and the current still image, a reference image corresponding to the segment; (d) cause capture, by the imaging system, of an incoming video stream containing frame images; and (e) during the capture of the incoming video stream: display, on a display screen of the computing device, the frame images of the incoming video stream; and for each frame image of a plurality of the frame images of the incoming video stream: responsive to a determination that a portion of the frame image has at least a threshold amount of content correlation with the reference image, generate a graphical indication demarcating the portion of the frame image; and display, on the display screen with the frame images of the incoming video stream being displayed, an overlay containing the graphical indication.

In embodiments, the front-end component is configured to, during (e): for each frame image of a plurality of the frame images of the incoming video stream: responsive to a determination that no portion of the frame image has at least the threshold amount of content correlation with the reference image, display, by the computing device with the frame images of the incoming video stream, the overlay without the graphical indication.

In embodiments, the front-end component is configured to, during (e): responsive to the determination, that the portion of the frame image has at least the threshold amount of content correlation with the reference image and a further determination that the portion is at least a threshold proportion of the frame image, at least one of: automatically capture, by the imaging system, a next still image of the region of interest; and instruct a user of the computing device to cause the imaging system of the computing device to capture the next still image of the region of interest.

In embodiments, the front-end component is configured to instruct the user of the computing device to cause the imaging system of the computing device to capture the next still image of the region of interest by changing a visible characteristic of the graphical indication demarcating the portion of the frame image.

In embodiments, the front-end component is configured to: responsive to a capture of the next still image, conducting (b), (c), (d), and (e) with the next still image as the current still image.

In embodiments, the front-end component is configured to: process the reference image to extract reference image keypoints; wherein to determine that the portion of the frame image has at least the threshold amount of content correlation with the reference image, the front-end component is configured to: process the frame image to extract frame image keypoints; determine one or more matches between the reference image keypoints and the frame image keypoints; generate a mapping of the reference image to the frame image based at least on the one or more matches; calculate an amount of overlap between the reference image and the frame image based on the mapping; and determine that the amount of overlap meets or exceeds a threshold amount of overlap.

In accordance with another aspect, there is provided a non-transitory computer readable medium embodying a computer program executable on a computing device, the computer program comprising computer program code for: (a) causing capturing, by an imaging system of a computing device, a current still image of a region of interest; (b) receiving location data that defines a location within the current still image of a segment of the current still image, the location data generated based on an identification of a hotspot within the current still image; (c) generating, based at least on the location data and the current still image, a reference image corresponding to the segment; (d) causing capturing, by the imaging system, an incoming video stream containing frame images; and (e) during the capturing of the incoming video stream: displaying, on a display screen of the computing device, the frame images of the incoming video stream; and for each frame image of a plurality of the frame images of the incoming video stream: responsive to a determination that a portion of the frame image has at least a threshold amount of content correlation with the reference image, generating a graphical indication demarcating the portion of the frame image; and displaying, on the display screen with the frame images of the incoming video stream being displayed, an overlay containing the graphical indication.

In embodiments, the computer program comprising computer program code for, during (e): for each frame image of a plurality of the frame images of the incoming video stream: responsive to a determination that no portion of the frame image has at least the threshold amount of content correlation with the reference image, displaying, with the frame images of the incoming video stream, the overlay without the graphical indication.

In embodiments, the computer program comprising computer program code for, during (e): responsive to the determination that the portion of the frame image has at least the threshold amount of content correlation with the reference image and a further determination that the portion is at least a threshold proportion of the frame image, at least one of: automatically capturing, by the imaging system, a next still image of the region of interest; and instructing a user of the computing device to cause the imaging system of the computing device to capture the next still image of the region of interest.

In embodiments, the computer code for instructing the user of the computing device to cause the imaging system of the computing device to capture the next still image of the region of interest comprises computer program code for changing a visible characteristic of the graphical indication demarcating the portion of the frame image.

In embodiments, the computer program comprising computer program code for: responsive to a capture of the next still image, conducting (b), (c), (d), and (e) with the next still image as the current still image.

In embodiments, the computer program comprising computer program code for: processing the reference image to extract reference image keypoints; wherein to conduct the determination that the portion of the frame image has at least the threshold amount of content correlation with the reference image, the computer program comprises computer program code for: processing the frame image to extract frame image keypoints; determining one or more matches between the reference image keypoints and the frame image keypoints; generating a mapping of the reference image to the frame image based at least on the one or more matches; calculating an amount of overlap between the reference image and the frame image based on the mapping; and determining that the amount of overlap meets or exceeds a threshold amount of overlap.

Other aspects and embodiments are disclosed herein.

### BRIEF DESCRIPTION OF THE DRAWINGS

FIG. 1 is a flowchart showing steps in a method of using a device to create a unique digital fingerprint of a physical artifact, according to an embodiment;

FIG. 2 is a flowchart showing steps in a method of generating an image capture set, according to an embodiment;

FIG. 3 is a diagram of a device having within its image capture field of view a region of interest containing a physical artifact, and in communication with a server via a network;

FIG. 4 is a diagram of the device having approached the physical artifact and having with its image capture field of view a segment of the region of interest of FIG. 3;

FIG. 5 is a diagram of the device having further approached the physical artifact and having within its image capture field of view another segment of the segment of the region of the interest of FIG. 4;

FIG. 6 is block diagram providing an overview of an implementation of an augmented reality (AR) landmarking feature of the front-end component of the application of FIG. 6;

FIG. 7 is a flowchart showing steps in an AR landmarking method, according to an embodiment;

FIG. 8 is a block diagram providing a more details overview of the implementation of the AR landmarking feature of FIG. 6; and

FIG. 9 is a block diagram of an example system including a client computing device and a server, where the client computing device executes a front-end component of an application, and the server executes a back-end service.

Other aspects and embodiments will become apparent upon reading the following description.

### DESCRIPTION

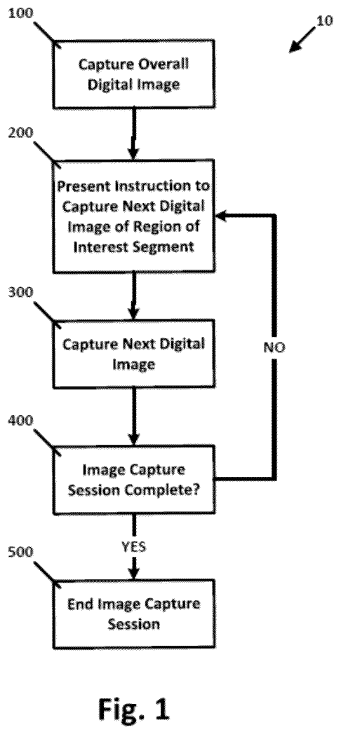

FIG. 1 is a flowchart showing steps in a method 10 of using a device, such as a computing device, to create a unique digital fingerprint of a physical artifact, according to an embodiment. An artist or authorized artist representative may initiate the creation of the unique digital fingerprint of an original artwork, such as a painting or drawing. The method may be implemented on a computing device such as a smartphone having an image capture device such as a camera, and which is equipped with a software application for assisting with image capture and for presenting instructions to a user.

In this embodiment, during an image capture session, a current digital image of a region of interest (step 100) is captured using the device, and an instruction to capture a next digital image of a segment of the region of interest (step 200) is presented by the device. In this description, the first digital image captured during an image capture session, such as an image capture session for creating a unique digital fingerprint of a physical artifact, is referred to as an overall digital image. An overall digital image is meant to capture the overall physical artifact within the image capture field of view of the device.

For example, if the physical artifact for which the digital fingerprint is being created is a painting, the overall digital image includes the overall painting within the image capture field of view of the device. It will be appreciated by persons of ordinary skill that the outer framing of an image being captured may be referred to as a landmark. During capture of the overall digital image, the device may be located and oriented with respect to the physical artifact so that the physical artifact substantially fills the image capture field of view of the device. In this way, the overall digital image may include very little, or no, other content besides the physical artifact itself. In some embodiments, digital images captured by an image capture device may themselves be single-capture images. In some embodiments, current and next digital images may each composite digital images each formed as a result of multiple captures. For example, a digital image may be formed from multiple image captures that are stitched together. As another example, a current digital image may be formed from multiple image captures that are overlaid on each other.

Instructions presented on the device to a user may include instructions to crop out any content in the overall digital image that is not attributable to the physical artifact. Cropping can be done by providing a user interface control enabling a user to bring the contours of the overall digital image adjacent to the physical artifact being represented within the overall digital image. In this way, content in the overall digital image that is not attributable to the physical artifact can be substantially removed from the overall digital image by the user.

Furthermore, it is preferred particularly for the overall image that the physical artifact be represented as fully within the focus plane of the image capture device as possible, so that little of the physical artifact is represented as blurry or skewed in the overall image. Automatic processing may be provided to process the overall image to determine whether there is a threshold amount of blurring and/or apparent skew. In the event that there is a threshold amount of blurring and/or apparent skew, the user may be requested to re-capture the overall image. Furthermore, the overall image may be processed to identify shadows or other extreme or differential lighting effects that are not inherent to the physical artifact but that are due to differential lighting being imparted onto the physical artifact. In some embodiments, such automatic processing is conducted at least partially on the image capture device. In some embodiments, such automatic processing is conducted at least partially by another device, such as a server.

The user may be requested to change the lighting (more or less lighting to avoid saturation/exposure effects and/or more uniform lighting to avoid incorrect feature identification) and or orientation of the image capture device in order to provide a sufficiently sharp, sufficiently unskewed, and sufficiently lighted and sufficiently uniformly lighted digital image of physical artifact. Such automatic processing may additionally be done at successive iterations of image capture, as a user physically approaching—or “landmarking”—the physical artifact may inadvertently impart a shadow on the physical artifact, or may otherwise capture light being imparted differently or differentially onto the physical artifact.

In this description, during a first iteration of image capture in the image capture session, the overall image is referred to as the current image. Due to the potential for iterative image captures during the image capture session, in a next iteration of image capture in the image capture session, the next digital image that had been captured will be referred to as the current digital image and yet another digital image to be captured is then called the next digital image.

In this embodiment, to assist with the method of creating a unique digital fingerprint, prior to the image capture session a user is requested to enter, into the device, dimensional details of the physical artifact, such as its height, width and thickness, in units such as centimetres or inches. Such dimensional details are used to correlate actual size of the physical object to the size of the overall image, and to derive the actual size(s) of successive segments of the region of interest during respective iterations of image capture.

For example, if the overall image is captured at a resolution of 4032 pixels in width by 3024 pixels in height, and the user specifies that a square-shaped physical artifact is 100 inches in width and 100 inches in height, then it can be inferred that each inch in width of the physical artifact is represented in the overall image by about 40 pixels and each inch in height of the physical artifact is represented by about 30 pixels. Accordingly, it can be inferred that a segment of the region of interest that is calculated to represent about 2000 pixels by about 1500 pixels of the overall image will represent about a 50 inch×50 inch segment of the physical artifact. Once the next digital image of that segment of the region of interest is captured at a pixel resolution of 4032 pixels in width by 3024 pixels in height, it can automatically be determined that each inch in width of the portion of the physical artifact captured in the next digital image is represented by about 80 pixels and that each inch in height of the portion of the physical artifact is represented by about 60 pixels. Provided that the zoom feature of the image capture device is not used, it will be appreciated that (in this example) at this iteration each inch of the physical artifact is being represented at double the resolution as it had been in the previous iteration.

Accordingly, it can be inferred that a segment of the region of interest that is calculated to represent about 2000 pixels by about 1500 pixels of the next digital image will represent about a 25 inch×25 inch segment of the physical artifact. It will be appreciated that next and subsequent digital images will, in this way, iteratively hone in on segments of the physical artifact to capture successive segments of the physical artifact at successively higher resolutions thereby to progressively more closely capture physical details of the physical artifact.

The user may be instructed not to use the zoom feature of the device when capturing successively images. Alternatively, the zoom feature may be automatically disabled so that the user cannot use it. In this way, the user is required to approach the region of interest during successive iterations of image capture, rather than to zoom in on it. By requiring the user to physically approach—or “landmark”—the region of interest—and in particular the physical artifact—for successive image captures, the device will be successively capturing higher and higher resolution images of smaller and smaller portions of the physical artifact itself. In this way, greater and greater optical detail about the physical aspects of the physical artifact can be captured using the device.

In this embodiment, the image capture session is completed when it is determined that the segment of the region of interest would capture less than a 3-inch×2-inch segment of the physical artifact. It will be appreciated that, generally-speaking, a very large physical artifact will require a higher number of iterations from overall image to ending of the image capture session to reach this lower size limit than will a smaller physical artifact. For example, a very large physical artifact may require seven (7) image captures whereas a smaller physical artifact may require three (3) image captures. If the physical artifact is itself very small—for example is 3-inches×2-inches or smaller—then only a single iteration may be required.

Other methods of capturing physical dimensional detail may be employed, such as by deploying a LIDAR sensor implemented on the device to assist with automatically obtaining the physical dimensions of the physical artifact.

The instruction for a user includes a graphical indication of the segment generated based on the current digital image. The graphical indication is any indication that sufficiently directs the user of the device to move towards the region of interest in order to fill the image capture field of view of the device with just the segment of the region of interest specified in the instruction. In an embodiment, the graphical indication of the segment is a graphical representation of the segment such as a part of the current digital image.

In another embodiment, the graphical representation of the segment is a graphical outline of a respective portion of the current digital image, such as a rectangular box encompassing only a portion of the current digital image. Alternative graphical indications for guiding the user as to which segment of the region of interest should fill the image capture field of view of the device may be provided. Furthermore, automatic feedback during an image capture session may be provided to a user as the user aims the image capture field of view towards the segment of the region of interest, thereby to guide the user to the instructed position and orientation so he or she can “register” that which is captured within the image capture field of view of the device with the segment.

In this embodiment, pursuant to the instruction being presented, the next digital image is captured (step 300). In the event it is determined that the image capture session is complete (step 400) then the image capture session is ended (step 500). An image capture session may be complete if it is determined that additional image captures are not required or are not desirable, for generating a unique digital fingerprint of the physical artifact.

Otherwise, another iteration of image capture continues from step 200 with the instruction including a graphical indication of the segment having been generated based on the next digital image that had been captured during step 300.

The overall digital image, next digital image and subsequently captured digital images during an iterated image capture session are associated with each other in an array as a capture set.

In this embodiment, each digital image captured by the device is transmitted to a server for processing prior to presenting the instructions. Based on the processing, the device receives data from the server corresponding to the graphical indication of the segment. In this embodiment, the server itself generates the data corresponding to the graphical indication of the segment. In particular, in an embodiment, a digital image received by the server is processed to identify at least one high entropy area (or “hotspot”) in the digital image. The data corresponding to the graphical indication of the segment identifies one such hotspot. In another embodiment, the digital image received by the server is processed to identify at least one low entropy area (or “coldspot”) in the digital image. The data corresponding to the graphical indication of the segment identifies one such coldspot.

The server may return actual digital image data to the device, or may alternatively return data simply defining the dimensions and position of the graphical indication of the segment with respect to the current digital image being processed. For example, if a hotspot is determined to be a small rectangular area in the middle of the current digital image that is 200 pixels×300 pixels, then data corresponding to the graphical indication of the segment may be data specifying a rectangle having 200 pixels×300 pixels centred at a position X, Y with respect to the current digital image. Such data may then be used by the device to present the whole of the current digital image with an overlaid rectangle of these dimensions and position, thereby to guide the user to fill the image capture field of view with just the segment of the region of interest corresponding to the content overlaid by the rectangle. Alternatives are possible.

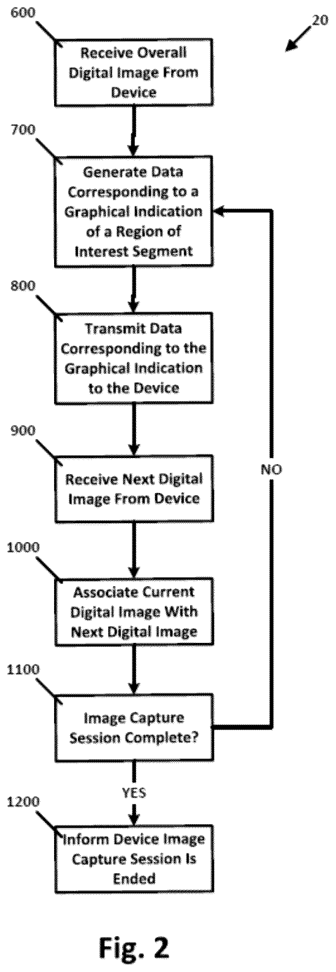

FIG. 2 is a flowchart showing steps in a method 20 of using a server to generate an image capture set for the unique digital fingerprint of the physical artifact, according to an embodiment.

In this embodiment, during an image capture session, an overall digital image captured of a region of interest is received from the device (step 600). Then, data corresponding to a graphical indication of a segment of the region of interest is generated (step 700). The data corresponding to the graphical indication of the segment is then transmitted to the device (step 800), so that the device may use the data to present its instruction to capture a next digital image of the segment of the region of interest.

In this embodiment, during the generating, the current digital image is processed to identify at least one high entropy area (“hotspot”) in the current digital image, wherein the data corresponding to the graphical indication of the segment identifies one hotspot by location, and may be considered location data. Furthermore, in this embodiment, the current digital image is processed to identify at least one low entropy area (“coldspot”) in the current digital image, wherein the data corresponding to the graphical indication of the segment identifies one coldspot by location, and may be considered location data.

In an embodiment, the data corresponding to the graphical indication of the segment is digital image data. Alternatively, the data corresponding to the graphical indication of the segment is data defining dimension and position of the graphical indication of the segment with respect to the current digital image.

After data corresponding to the graphical indication of the segment is transmitted to the device at step 800, a next digital image is received from the device (step 900) and associated with the current digital image in an image capture set (step 1000). In the event it is determined that the image capture session is complete (step 1100) then the device is informed that the image capture session is ended (step 1200). An image capture session may be complete if it is determined that additional image captures are not required or are not desirable, for generating a unique digital fingerprint of the physical artifact.

Otherwise, another iteration of image capture continues from step 700 with the instruction including a graphical indication of the segment having been generated based on the next digital image that had been received during step 900.

A high entropy area, or “hotspot”, is an area of the current image having a concentration of information, such as an area with relatively high amounts of creative detail, such as quickly changing contrasts. For a physical artifact that is a painting, a hotspot may be an area encompassing at least part of a subject's bangs, a wig, wisps of hair, or other areas of high amounts of creative detail.

A low entropy area, or “coldspot”, is an area of the current image that has diffuse information, such as an area with relatively low amounts of creative detail, such as low or slowly changing contrasts. For a physical artifact that is a painting, a coldspot may be an area encompassing at least part of a shadow, a clear blue sky, or an unpainted region of a canvas.

It will be appreciated that hotspots and coldspots, once identified, may be processed differently from each other using different image processing techniques. For example, for a physical artifact that is a painting, a hotspot may be processed generally with a view to identifying creative features imparted by the artist, whereas a coldspot may be processed with a view to identifying non-creative features such as bumps in a canvas, or the texture or material of the canvas. It will be appreciated that a process of uniquely fingerprinting and subsequently identifying a physical artifact may determine such hotspot and coldspot features thereby to uniquely identify the physical artifact itself as distinct from a physical reproduction which may be absent of a sufficient number of the hotspot and coldspot features to distinguish it from the original.

Hotspot processing may be oriented generally more towards identifying creative features of the physical artifact and coldspot processing may be oriented generally towards identifying non-creative features of the physical artifact. However, these are not intended to be always mutually exclusive. For example, hotspot processing may not necessarily preclude the identification of non-creative features and coldspot processing may not necessarily preclude the identification of creative features. Rather, it may be that hotspot processing tends towards or is oriented towards, but is not exclusive to, identification of creative features and coldspot processing tends towards or is oriented towards, but is not exclusive to, identification of non-creative features.

Both hotspot and coldspot processing involves detecting and/or processing clusters of features within sliced regions of the current digital image. The number of rows and columns into which a current digital image is divided to form the sliced regions may be determined automatically based on the physical dimensions of the physical artifact and the derived physical dimensions of the subsequent digital images captured during an image capture session. Upper and lower thresholds may be established to set bounds on numbers of rows and/or columns. In some embodiments, other processing in addition to hotspot and coldspot processing, may be conducted.

In this embodiment, feature processing is conducted in order to detect feature keypoints in a current digital image. Various techniques or processes for detecting features in digital images are available. Various configurations of hardware and software are available for conducting feature processing. Furthermore, feature processing or elements of feature processing may be conducted using an Application Specific Integrated Circuit (ASIC), or some other hardware processor or a software defined processor. The coordinates of the feature keypoints in the current digital image are stored in association with the current digital image. Hotspot and coldspot areas are then determined by processing the feature keypoints and their concentration or diffusiveness, and the coordinates are employed to determine the segment of the region of interest to capture during the next iteration of image capture.

As described above, during feature processing for detecting feature keypoints, one or more different feature detection processes may be employed and/or one or more different tunings of a particular feature detection process may be employed. Feature detection may therefore be conducted using what may be referred to as a feature detection “jury” of one or more different feature detection processes and/or one or more different tunings of a particular feature detection process. In this description, tuning refers to configuration of a feature detection process in a particular way according to one or more feature detection parameters.

Such a feature detection jury may consist of a single feature detection process, thereby to function as a jury of only one juror. For example, a feature detection jury may consist simply of feature detection process 1. Such a feature detection process may have a particular respective tuning.

Alternatively, a feature detection jury may consist of more than one instance of a particular feature detection process, with each instance tuned in respective different ways, thereby to together function as jury of multiple jurors. For example, a jury may consist of an instance of feature detection process 1 having a first tuning, and an instance of feature detection process 1 having a second, different tuning. As another example, a jury may consist of an instance of feature detection process 1 having a first tuning, an instance of feature detection process 1 having a second and different tuning, and an instance of feature detection process 1 having a third and still different tuning. It should be appreciated that a feature detection jury may consist of more than three instances of a particular feature detection process, each having respective, different tuning.

Alternatively, a feature detection jury may consist of multiple different feature detection processes, thereby to function as a jury of multiple jurors. For example, a jury may consist of an instance of feature detection process 1 and an instance of feature detection process 2. As another example, a jury may consist of an instance of feature detection process 1, an instance of feature detection process 2, and an instance of feature detection process 3. A feature detection jury may consist of instances of more than three feature detection processes.

Alternatively, a feature detection jury may consist of multiple different feature detection processes and, for one or more of the different feature detection processes, more than one instance of the particular feature detection process, with each instance tuned in respective different ways, thereby to together function as a jury of multiple jurors. For example, a jury may consist of an instance of feature detection process 1 having a first tuning, an instance of feature detection process 1 having a second, different tuning, and an instance of feature detection process 2 having a respective tuning. As another example, a jury may consist of an instance of feature detection process 1 having a first tuning, an instance of feature detection process 1 having a second, different tuning, an instance of feature detection process 2 having a third tuning, and an instance of feature detection process 2 having a fourth tuning that is different from the third tuning. A feature detection jury may consist of instances of more than two feature detection processes and/or of more than two respective tunings of a particular feature detection process.

A jury of multiple jurors may, by providing a diversity of feature detection approaches, provide improved feature detection and accordingly improved quality and integrity when generating a unique digital fingerprint for a particular physical artifact as well as improved quality and integrity during authentications of the physical artifact.

In some embodiments, the server is configured to have two main components for use in creating unique digital fingerprints and for validating images of a physical artifact against the unique digital fingerprints. The first is configured to conduct feature extraction and match detection. The second is configured to act as a microservice, interfacing with other backend subsystems. This microservice may use an API (Application Programming Interface) to interface with the other systems and to conduct validation of feature data and to handle other business logic. Various API implementations are available. Other implementations are possible.

The segment of a region of interest for which data is generated may indicate a hotspot, such that the user of the device is instructed to capture within the image capture field of view of the device a portion of the physical artifact that corresponds to a hotspot. The segment of a region of interest for which data is generated may indicate a coldspot, such that the user of the device is instructed to capture within the image capture field of view of the device a portion of the physical artifact that corresponds to a coldspot. In two successive iterations of image capture during an image capture session, the data may indicate a first hotspot and then a second hotspot within the first hotspot.

Alternatively, in two successive iterations of image capture during an image capture session, the data may indicate a first hotspot and then a first coldspot within the first hotspot. Alternatively, in two successive iterations of image capture during an image capture session, the data may indicate a first coldspot and then a first hotspot within the first coldspot. Alternatively, in two successive iterations of image capture during an image capture session, the data may indicate a first coldspot and then a second coldspot within the first coldspot. It will be appreciated that hotspots and coldspots may be determined based on relative entropy within a particular image.

In an embodiment, an image capture set captured during an image capture session may be characterized as a hotspot image capture set. In such an embodiment, once an overall image is received the successive segments of the region of interest include a hotspot, a hotspot within a hotspot, a hotspot within a hotspot within a hotspot, and so forth.

Similarly, in an embodiment, an image capture set captured during an image capture session may be characterized as a coldspot image capture set. In such an embodiment, once an overall image is received the successive segments of the region of interest include a coldspot, a coldspot within a coldspot, a coldspot within a coldspot within a coldspot, and so forth.

Alternatively, in an embodiment, for each current digital image, both at least one coldspot and at least one hotspot may be identified and associated with a respective image set, with only the data corresponding to one hotspot or one coldspot being transmitted to the device for the purpose of instructing a user as to the next digital image to capture during the image capture session. As such, while a user may be instructed based on only one of these during a given iteration, both a coldspot image set constituted of one or more coldspots and a hotspot image set constituted of one or more hotspots may continue to be built up in respect of a given physical artifact.

During initial creation of a fingerprint, a user may be requested to repeat an image capture session thereby to validate the captures done a second time against the captures done the first time. In the event that such validation cannot be done, the capture set(s) are rejected and the user is asked to attempt the creation of the unique digital fingerprint of the physical artifact anew.

It will be appreciated that processing a current digital image may include globally or locally processing the current digital image prior to hotspot/coldspot identification and prior to feature identification. For example, a current digital image may be first converted from RGB colour to greyscale or black and white, or may be processed in other ways to produce a processed current digital image that is suitable for downstream processing.

During validation of a physical artifact—at some time after the unique digital fingerprint of the physical artifact has been generated—the Linux binary deploys a feature detection process by attempting to locate the presence of an object digital image (a candidate being checked for validation) within a scene digital image (the canonical capture image represented by the capture set, and thus the unique digital fingerprint). In this embodiment, validation includes preprocessing the scene and object images. Preprocessing may include converting the scene and object digital images to greyscale, so that only contrast is considered during validation. Keypoints and features are then extracted from both the scene and object digital images, thereby to create scene keypoints and object keypoints. In the event that keypoints cannot be detected, as could happen if there is a poor image capture, then an exception is raised so that a better digital image can be captured for the processing. Matches between the scene keypoints and object keypoints are then computed. In the event that less than a threshold number of matches is determined, then an exception is raised indicating that there is no match between the scene and object digital images.

Otherwise, in the event that at least a threshold number of matches is determined, it is then determined whether a homography between the scene keypoints and the object keypoints can be found. In the event that no such homography can be found, then an exception is raised indicating that there is no match between the scene and object digital images. Otherwise, in the event that a homography can be found, and can be expressed in a homography transformation matrix, the four corners of the homography transformation matrix are extracted for validation. During validation, in this embodiment it is determined whether the homography matrix represents a trapezoid with an internal angle sum between 360° with a forgiveness for a tolerable variance such as 10°, and a rejection if any one such angle is too acute such as less than 40°. While a particular tolerance level and a particular level of acuteness has been described, it will be appreciated by the skilled reader that other tolerance levels and levels of acuteness could be used without departing from the purpose of this description.

It is thereby determined that such geometry is a trapezoid valid within tolerances, thereby to rule out any homography projections that would be uncharacteristic of a match between and object digital image and a scene digital image, such as a twisted or semi-inverted homography, or one that indicates digital image contents compressed into a straight line. In the event that validation of the homography matrix succeeds, a match between the scene digital image and the object digital image is registered and the physical object is deemed the same physical object captured during creation of the unique digital fingerprint data. The server then informs the device that, in turn, presents feedback to the user of the device that the physical artifact is confirmed.

Otherwise, an exception is raised indicating that there is no match between the scene and object digital images, and the feedback presented to the user of the device is that the physical artifact is not confirmed.

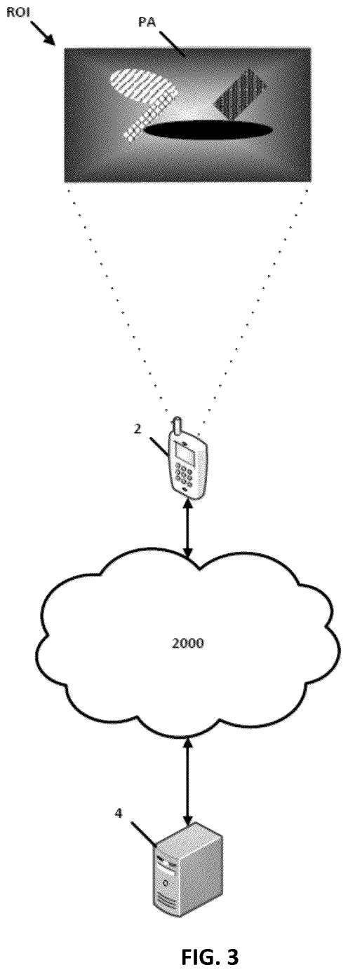

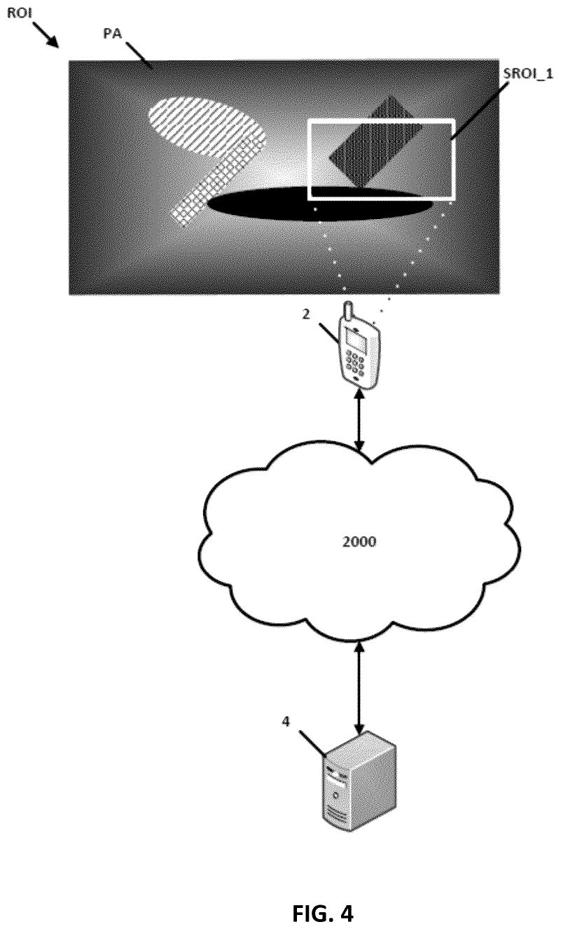

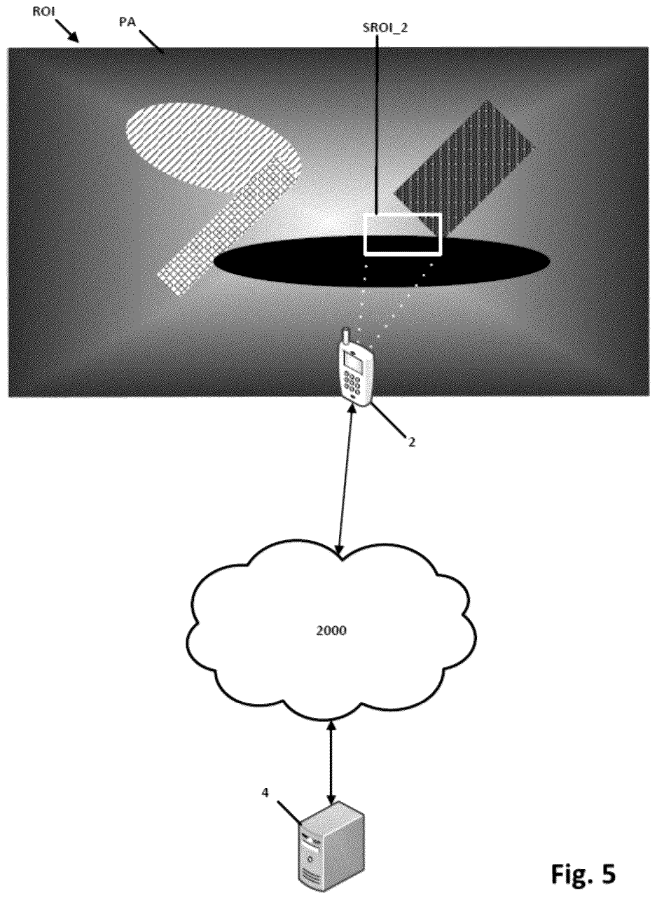

FIG. 3 is a diagram of a device 2 having within its image capture field of view a region of interest ROI containing a physical artifact PA, and in communication with a server 4 via a network 2000. FIG. 4 is a diagram of device 2 having approached the physical artifact PA and having with its image capture field of view a segment SROI_1 of the region of interest ROI of FIG. 3. In this embodiment, the segment SROI_1 is represented by a graphical indication that is a rectangular box. The rectangular box would be displayed on device 2 for the user to see. FIG. 5 is a diagram of device 2 having further approached the physical artifact PA and having within its image capture field of view another segment SROI_2 of the segment SROI_1 of the region of the interest ROI of FIG. 4. In this embodiment, the segment SROI_2 is represented by a graphical indication that is a rectangular box. The rectangular box that would be displayed on device 2 for the user to see. It can be seen that as a user responds to the instruction presented on device 2 at successive iterations of image capture, the device 2 is brought physically closer to the physical artifact in order to capture the segment at as high a resolution as possible using device 2.

To validate the validation process described above, Perceptual Hash (phash) checks have been conducted to determine a score corresponding to the closeness of the scene and object digital images. Such checks have generally been found to correlate with the feature and homography checks described above, in that higher phash scores have manifested in the event that a physical artifact has been confirmed.

Phash validations or confirmatory validations can be useful where it is generally the case that one can expect an identical bit-for-bit digital image to be found within another image, such as in the case of digital copying. However, perturbations such as background information in a digital image capture can throw off a phash. In an embodiment, data is captured during validations that can be used for adding to the digital fingerprint. In this way, a digital fingerprint itself can continue to evolve to take into account gradual changes in the physical artifact due to age or changes due to damage. However, because a physical artifact may physically evolve in a way that a purely digital asset would not, comparing unprocessed phashes based on images of physical artifacts captured at different times and under different conditions can easily produce false negatives. As such, to account for this, the processes described herein for using features for validation may be conducted, and then once the physical artifact has been validated, a modified phash may be produced.

For example, in an embodiment, intermediate outputs of feature processing may be used to, as described above, determine a valid homography between digital scene and object images. For example, a homography may be applied to ensure the object features correspond to respective scene features, with the matching trapezoid constraints detailed above. The trapezoid is then cropped to leave some trim area in four corners outside of the trapezoid region while showing scene data. The homography is then recalculated and re-applied with the cropped trapezoid region back to the object thereby to un-skew the object digital image. Trimming is conducted again to result in a skew-adjusted matching common area across both scene and object digital images.

It will be appreciated that, while to the human eye these modified scene and object digital images are virtually identical, they will incorporate differences in how the object was digitized by the sensor. The contrast profile, however, will be substantially the same. At this point, the two so-transformed digital images can be phashed, such that each digital image has an associated hash value in the form of a string, hex string or binary value. A phash score can thereafter be calculated by calculating a Hamming distance between the two strings. In particular, by summing the 1's that result when the hash value is XOR'd. The Hamming distance provides a score as to how different the two digital images are, and the inverse of this score is how similar the two digital images are. It will be appreciated that the phash score in this circumstance should be relatively high because the images are feature matched too, and matched/skewed/unskewed/trimmed to be the same region.

It will be appreciated that the data encoded in the images of the image capture set(s), as well as the data encoded about the relationships between the images in an image capture set, function as the unique digital fingerprint of a physical artifact. While this data is fixed once captured, it is not flattened from its multi-image, multiple-relationship format into a sort of fixed, single-file set of pixels or some other flattened representation. Such a flattening would be at a higher risk of filtering out data useful for distinguishing a reproduction from an original. Rather, in the present description, image pixel data captured during iterations of image capture is primarily preserved, as are the relationships between segments. In this way, a candidate physical artifact can be captured in similar manners to capture data encoded in images at different iterations and about relationships between the images in a candidate image capture set, and can be feature-compared at different “levels” of the iterations, rather than at only a flattened level.

Furthermore, by preserving the data encoded in the images of the image capture set(s) and the relationships between the images in an image capture set for the purpose of digital fingerprinting, validation as described herein may be made more resilient to changes in a physical artifact that may occur over time due to age or due to damage to the physical artifact.

Systems and methods for further aiding a user using the mobile device with the task of locating a segment of the region of interest so that it may be approached for a next digital image capture, are desirable. The following is directed to the architecture of an example system and to its operation for enabling a user to be guided using a particular form of augmented reality that is generated and presented using the mobile device.

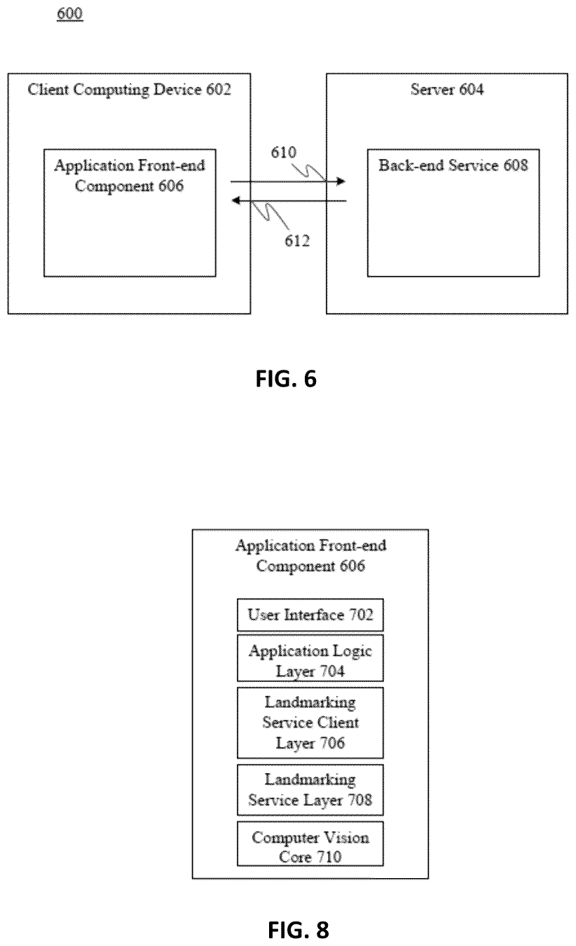

FIG. 6 is a block diagram of an example system 600 including a client computing device 602 and a server 604. Client computing device 602 is similar to client computing device 2, except that client computing device 602 additionally executes an application front-end component 606 of an augmented reality (AR) landmarking application, as will be described. Service 604 is similar to server 4, and particular aspects of server 604 are referred to below as providing a back-end service 608 relevant to the AR landmarking application.

In this example, application front-end component 606 may be configured to enable users of client computing device 602 to capture images of a physical artifact, for example an artwork, using an image capture device of client computing device 602, and to provide the images to back-end service 608. Back-end service 608 may be configured to analyze each of the captured images and identify segments of regions of interests (ROI), also referred to as hotspots.

Client computing device 602 and server 604 may be communicatively interconnected via one or more networks (not pictured in FIG. 6). These one or more networks may include, for example, a local area network (LAN), a wide area network (WAN), a personal area network (PAN), and/or a combination of communication networks, such as the Internet.

Client computing device 602 may be any type of stationary or mobile computing device, including a mobile computer or mobile computing device (e.g., a smart phone, a laptop computer, a notebook computer, a tablet computer such as an Apple iPad™, a netbook, etc.), a wearable computing device (e.g., a smart watch, a head-mounted device including smart glasses such as Google® Glass™, etc.), or a stationary computing device such as a desktop computer or PC (personal computer). However, as landmarking by continually approaching a physical artifact to capture images of segments of the physical artifact is most usefully done using a mobile device, it is likely that client computing device 602 will be mobile. Server 604 may include one or more server devices and/or other computing devices.

In some embodiments, application front-end component 606 and back-end service 608 may be example components of a web accessible application/service hosted in a cloud services network, which may host resources associated with application front-end component 606. For example, in some embodiments, application front-end component 606 may be an Internet-enabled application executing on client computing device 602. As another example, in other embodiments, application front-end component 606 may be represented as a web page displayed in a web browser. Still other implementations of application front-end component 606 are possible.

For certain tasks, application front-end component 606, executing on client computing device 602, may communicate with back-end service 608 hosted on server 604. For example, and with continued reference to FIG. 6, back-end service 608 may be configured to receive, from client computing device 602, digital capture or image data 610 (e.g., a JPEG file which may be paired with metadata) captured of a physical artifact, and as previously described, analyze the digital image data 610 to identify at least one hotspot.

Based on an identified hotspot, back-end service 608 may be further configured to generate location data 612 associated with a location of the hotspot within a spatial context of the captured image of the physical artifact and transmit the location data 612 to client computing device 602. For example, location data 612 may comprise any combination of positional coordinates, dimensions, and other attributes correlating the location of the hotspot within the spatial context of the digital image. For example, a location of the hotspot within a spatial context of the captured image may be represented in the location data as a tuple of four values: (x, y, width, height), where “x” and “y” represent the top-leftmost corner of a (rectangular) boundary of the hotspot (the unit in pixels). In addition, the “width” and the “height” values represent the width and the height of the boundary, in pixels. In some embodiments, the location may be represented in the location data as two coordinates and a height or a width value. In some embodiments, the location may be represented in the location data as include four coordinates representing four corners of the boundary of the hotspot.

Application front-end component 606 may be configured to use location data 612 in the manners described herein, to generate and display an AR overlay corresponding to the location data 612 atop images (i.e. video frames) being continually captured by, and presented in the viewfinder of, the computing device 602. The AR overlay being presented in the viewfinder of the computing device in association with a respective location of the hotspot in the viewfinder may serve to visually highlight or otherwise demarcate for the user the location of the hotspot in the physical artifact as the user uses the computing device 602 to capture the physical artifact itself. It should be appreciated that the overall capture of the physical artifact itself may function as a “hotspot”, such that the AR overlay may be presented in the viewfinder of the computing device to highlight or otherwise demarcate for the user the location of the physical artifact relative to or within extraneous settings, such that the user may landmark to capture or re-capture the overall capture of the physical artifact.

In general, application front-end component 606 functions in conjunction with back-end service 608 to enable a user to capture as a still image using an imaging system (for example, by a still image camera imaging device of an imaging system) a current digital image of a region of interest containing a physical artifact and to process that current digital image to determine a location of a hotspot. In order to aid the user with capturing a next digital image of a segment of the region of interest corresponding to the hotspot, application front-end component 606 uses the location of the hotspot and the current digital image to generate a reference image. Application front-end component 606 then processes the reference image and incoming image frames of a video stream captured by the imaging system (for example, by a video camera imaging device of the imaging system) of the computing device 602 to determine whether, and to what extent, the reference image is contained within incoming image frames. That is, to determine whether the user is positioning and orienting the computing device 602 to capture at least the hotspot within the field of view of its imaging device. When the reference image is indeed contained within incoming frames, application front-end component 606 combines a graphical indication such as a bounding box with those frames as they are displayed on a viewfinder (i.e. a display screen) of the computing device 602. As the user moves the computing device 602 with respect to the region of interest, the graphical indication itself remains associated with, and thus tracks, the hotspot on the viewfinder. If the hotspot leaves the field of view of the computing device 602 due to the user having moved the computing device 602 such that the field of view of the imaging system is sufficiently away from the physical artifact, then the graphical indication is not displayed. The user may move the computing device 602 back to face the physical artifact and the graphical indication may again be displayed. It will be appreciated that by having the computing device 602 track the hotspot with the graphical indication the user is provided with visual feedback generally in real-time as to the position and orientation of the hotspot: whether it is there, where in the viewfinder it can be found, and whether it is being approached as the user moves the computing device 602 towards the physical artifact. As the user approaches the physical artifact with the continually updated guidance of the graphical indication, it will be appreciated that the size of the hotspot in the image frames being captured, and thus in the image frames being displayed, will progressively increase. Accordingly, the graphical indications are generated to correspondingly increase in size so that it can continue to demarcate and track the hotspot for the user. The application front-end component 606 may, once the computing device 602 has the hotspot filling the field of view of the imaging device sufficiently, automatically capture an image to be used as the next digital still image to be transmitted to the back-end service 608, or instruct the user to interact with the user interface to capture the next digital still image. This next digital still image, encompassing primarily just the initial hotspot, may thereafter be processed by back-end service 608 as described herein in connection with the current digital still image to determine a location of a next hotspot for additional AR landmarking to guide the user in a similar manner towards a hotspot-within-the-hotspot. This may iterate until such time as the back-end service 608 deems it unnecessary to continue to progressively capture hotspots at greater and greater resolutions.

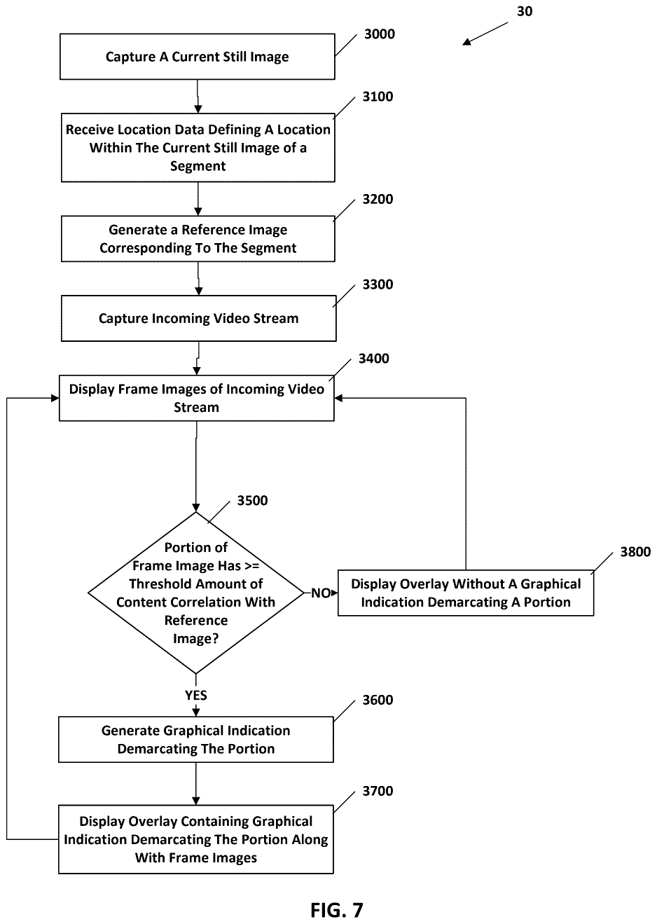

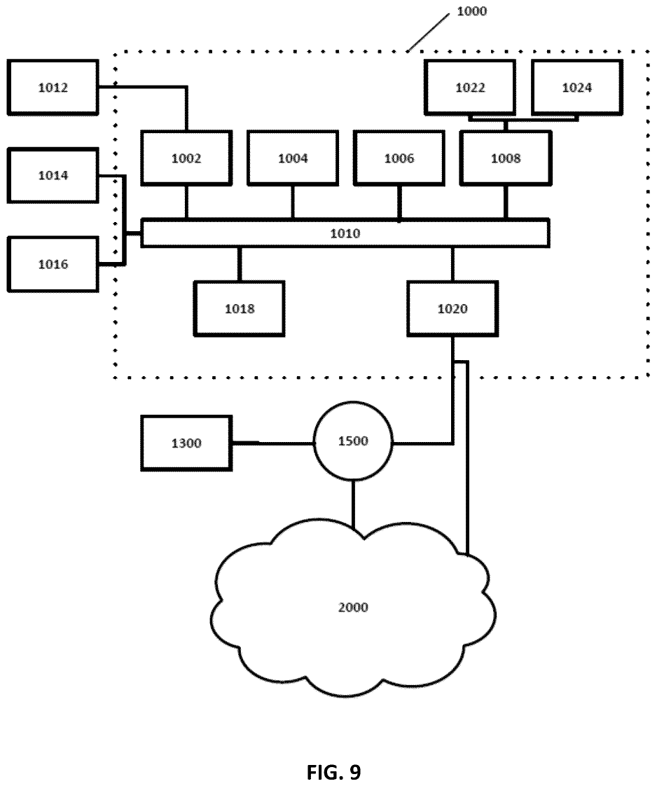

FIG. 7 is a flowchart showing steps in a method 30 for providing AR landmarking guidance to a user. Method 30 may be executed by client computing device 602. During the method, a current still image is captured (step 3000) and location data defining a location within the current still image of a segment, is received (step 3100). The location data defining the location may be generated by the backend service 608 on server 604 upon receipt from client computing device 602 of the current still image, in a manner described herein. For example, the location data defines the position and size, in the current still image of the segment, of a hotspot. With the location data having been received, the method 30 generates a reference image corresponding to the segment (step 3200). Either automatically or at the request of a user, a landmarking session may be initiated that can help guide the user to bring the client computing device 602 towards the physical artifact for a next still image capture. During the landmarking session, an incoming video stream is captured (step 3300), and frame images of the incoming video stream are displayed (3400). While video streams are used as an example, the method 30 may similarly be applicable to other streams of data that include frames of optical information and non-optical metadata. During the displaying of the frame images of the incoming video stream, certain of the frame images are processed to make a determination as to whether a portion of each frame image being processed has at least a threshold amount of content correlation with the reference image (step 3500). In this description, content correlation corresponds to overlap between the reference image and the frame image. That is, if the contents of the reference image can be matched entirely to contents of the frame image, then the reference image may be considered contained within the frame image, corresponding to the hotspot being contained within the frame image. If the contents of the frame image can be matched only partially to contents of the frame image, then there is a level of content correlation that indicates some overlap. If the contents of the frame image cannot be matched at all to contents of the frame image, then there is no content correlation indicating no overlap. In this latter case, the field of view of the imaging system of computing device 602 is considered not to be facing a segment of the region of interest that contains the hotspot, and may indeed not be facing the physical artifact at all. In the event that there is at least a threshold amount of content correlation, corresponding to at least a sufficient amount of the hotspot being within the field of view of the imaging device, then a graphical indication is generated that demarcates the portion (step 3600) and an overlay is displayed that contains the graphical indication demarcating the portion along with the frame images being displayed (step 3700). In this way, a user is provided with visual guidance for approaching the hotspot for a next still image capture. On the other hand, in the event that there is not at least the threshold amount of content correlation, corresponding to the hotspot not being sufficiently within the field of view of the imaging device or being entirely outside of the field of view of the imaging device, then the overlay is displayed without a graphical indication demarcating the portion (step 3800). It will be appreciated that, as an incoming video stream is captured, depending on whether the user directing the field of view of the imaging device of the computing device 602 at the region of interest or away from it, certain frame images of the video stream may contain the hotspot and certain frames may not. Method 30 enables a user to be guided in identifying the hotspot when it is contained within an image frame, and will not be misled by a graphical indication when the hotspot is not contained within an image frame. As such, a user holding computing device 602 steadily such that, even if the user approaches the physical artifact the hotspot remains within the field of view frame image after frame image, the graphical indication corresponding to the hotspot will continue to be displayed along with the frame images in the incoming video stream, and will appear in the display device of the computing device 602 to grow or shift as it tracks the hotspot. A user turning the field of view away from the physical artifact will cause the imaging system of the computing device 602 to capture frame images that do not contain the hotspot such that processing of these frame images for content correlation with the reference image will result in no content correlation, which will accordingly cause method 30 to display an overlay without a graphical indication. It will be appreciated that the overlay may include additional features available to the user, such as onscreen buttons selectable by the user for use in starting and stopping the AR landmarking process. However, whether during AR landmarking the overlay contains the graphical indication demarcating the portion corresponding to the hotspot will depend on the processing of method 30, which will ultimately depend on in which direction the user has the field of view of the imaging device.

FIG. 8 provides an overview of components of the AR landmarking feature of application front-end component 606, in an embodiment. In this embodiment, the AR landmarking feature is organized into a multi-layered software architecture, where each layer has a role in the functionality of the AR landmarking feature. As depicted in FIG. 8, application front-end component 606 includes, from bottom to top, the following layers: a computer vision core 710, a landmarking service layer 708, a landmarking service client layer 706, an application logic layer 704, and a user interface (UI) layer 702. The architecture described for the AR landmarking feature of application front-end component 606 represents one possible configuration to implement functionality described herein and to manage processing within application front-end component 606. However, it is important to note that the functionality of application front-end component 606 may be organized in various other formats depending on requirements, constraints, and design preferences of a particular implementation.

In this embodiment, computer vision core 710 and landmarking service layer 708 execute on a first thread, referred to herein as a computation thread, whereas landmarking client service layer 706, application logic layer 704, and UI layer 702 all execute on a second thread, referred to herein as a UI thread. This multi-threaded architecture enables the heavy computation required by the computer vision core 710 to be performed relatively independently of the UI interactions required of the other layers.

Computer vision core 710 processes image data. In this embodiment, computer vision core 710 exposes two functions to higher layers. The first of these is setReferenceImage, for receiving a reference image from a higher layer that can serve as the reference image to which frame images can be compared. The second of these is findBoundingPolygon, for receiving a frame image stored by a higher layer in a frame image queue, comparing the frame image to the reference image, and producing computation results corresponding to a bounding polygon of a hotspot for storage in a computation cache that, in turn, can be read by a higher layer for downstream use in guiding the user of computing device 602.

In this embodiment, computer vision core 710 is configured to receive the reference image (in a common format such as JPEG) during a call to setReferenceImage by a higher layer and to analyze the reference image to identify reference image keypoints. It will be appreciated that reference image keypoints are distinct features within the reference image. In this embodiment, computer vision core 710 uses the reference image keypoints to build an indexing data structure that will be made use of to recognize the same or similar features in other images to be compared with the reference image. Computer vision core 710 is also configured to receive and process such other images received during a call to findBoundingPolygon by a higher layer. Such other images, in this embodiment, are certain (or all, if computationally possible and desirable for an implementation) of those frame images captured by client computing device 602 as video streams, in order to identify frame image keypoints. Computer vision core 710 processes one frame image at a time and may not even-due to being occupied with current processing-process certain of the frame images that may have been placed by a higher layer into the frame image queue as they are captured by computing device 602 to replace a previous frame image placed previously in the frame image queue. Regarding processing of a given frame image, it will be appreciated that frame image keypoints are distinct features within the frame image. In this embodiment, computer vision core 710 compares frame image keypoints obtained from the given frame image retrieved from the frame image queue by computer vision core 710 with reference image keypoints in the indexing data structure identified in the reference image to find matches.

If matches are found, the matched keypoints may also be used to construct a homography for the reference image and a matched frame image. It may be appreciated that a homography is a mathematical transformation that relates two images, in this example allowing for points in the reference image to be mapped to corresponding points in a given frame image. For the sake of illustration of this concept, assume the coordinates (0, 0, reference_image_width, reference_image_height), represent the upper left corners and a width and height, in pixels, of the reference image in its own frame of reference. Using homography, computer vision core 710 calculates the position of these corners within the frame of reference of the frame image. This enables computer vision core 710 to determine where the reference image would be placed and how it would fit within the perspective that captured the frame image. In this embodiment, computer vision core 710 then calculates an overlap location using coordinates from both the reference image and the frame image, thereby to provide the location of the reference image within the frame image as a set of coordinates. In this example, the location may be codified as corner points of a bounding polygon such as rectangle, denoted as ((x1, y1), (x2, y2), (x3, y3), (x4, y4)). In this embodiment, the set of coordinates may be normalized. For example, each coordinate may be scaled to a range of 0 to 1 to indicate relative position regardless of sizes of the images. Additionally, in this embodiment, overlapping percentages of the reference image and the frame image indicating the degree to which the reference image and the frame image overlap when one is superimposed onto the other, are generated by computer vision core 710.

In this embodiment, computer vision core 710 is also configured to produce the image analysis results in a form suitable to be passed “upwards” to application logic layer 704 and UI layer 702 to render informative UI elements to guide the end user. As previously described, computer vision core 710 produces coordinates of the bounding polygon. In this embodiment, in a scenario in which a matching polygon cannot be found due to there being insufficiently matching reference image and frame image keypoints, an “empty” bounding polygon result is returned by computer vision core 710. This empty result serves to inform higher layers that a bounding polygon is not to be rendered. Regarding the production by computer vision core 710 of overlap percentages between a frame image and the reference image, this overlap value may range from [0, infinity]. For example, when this overlap value is set by computer vision core 710 to zero (0), this may be interpreted by higher layers to mean that the frame image has no overlap with the reference image. On the other hand, when this overlap value is set by computer vision core 710 to be within the range of [0, 1), this may be interpreted by higher layers to mean that most of the reference image is contained within the frame image. That is, that the reference image may be interpreted as being in a subset of the frame image. Still further, when this overlap value is set by computer vision core 710 to be larger than 1, this may be interpreted by higher layers to mean that the frame image is fully contained within the reference image. In this scenario, it may be considered that, if one were to overlay the reference image on top of the frame image, the borders of the reference image would fully enclose the frame image.

Overlap percentages calculated by computer vision core 710 and stored in a computation cache may be used by higher layers, such as UI layer 702, to generate guidance or instructions for users to move closer to a physical artifact, to hold still with respect to the physical artifact, or to move back somewhat from the physical artifact. For example, there may be established three scenarios (1) where the overlap percentage is below a minimum threshold, such as 0.8, the user may be instructed (i.e., “prompted”, for example using sound or other information displayed as part of an overlay generated and displayed by UI layer 702 as will be described) to move computing device 602 closer to the physical artifact; (2) where the overlap percentage is within a particular range, such as 0.9 to 1.1, the overlap between the frame and the reference image is sufficient enough that the user may be instructed to simply hold the computing device 602 steady so that some automatic focusing and/or automatic or user-triggered capturing of a next still image can be performed; and (3) where the overlap percentage is above a top threshold, such as 1.3, the user may be instructed to move computing device 602 backwards with respect to the physical artifact. It should be appreciated that an “image”, in this step and in other steps, may include a composite or array of multiple images, for instance captured while instructing the user to simply hold the computing device 602 steady.

Landmarking service layer 708 is the layer just above computer vision core 710. Like computer vision core 710, landmarking service layer 708 executes on the computation thread. Landmarking service layer 708 also exposes two functions to higher layers that each may be thought of as mimicking a respective one of those exposed by computer vision core 710. That is, landmarking service layer 708 exposes a setReferenceImage function and a findBoundingPolygon function to higher layers so that the higher layers may call and send and receive data to and from the setReferenceImage and findBoundingPolygon functions of landmarking service layer 708, which are at least in part relayed by landmarking service layer 708 to computer vision core 710. Landmarking service layer 708 also establishes inter-thread communications between the computation thread and the UI thread thereby to enable communications to pass between layers while exerting control over the relative execution independence of the UI thread and the computation thread. The multi-threaded approach keeps any heavy image processing performed by computer vision core 710 from impeding user interface interactions. In this way, the UI thread can handle capture and sending of a stream of frame images captured by a camera of client computing device 602, through the inter-thread communications, to landmarking service layer 708 for populating the frame image cache. Regarding the frame image cache (or “queue”), landmarking service layer 708 is configured to establish a queuing system including the frame image cache, for receiving and caching at least one frame image at a time from the stream of frame images sent through by the UI thread after the reference image has been established using setReferenceImage.

The queuing system is provided to manage intake of frame images received at high frame rate (e.g., thirty frames per second (fps)), by the imaging system of computing device 602. For example, at 33 fps (frames per second), it is implied that each frame image is given approximately 30 milliseconds of computation “budget” to find a bounding polygon using the findBoundingPolygon function provided by computer vision core 710. As another example, at 15 fps, the computation budget would be about 67 milliseconds. Since this computation budget may be too small for a given processing structure (i.e., single processor or a set of processors) of a given computing device 602, the queuing system is established to handle what may otherwise become a backlog of frame images waiting to be potentially processed while computer vision core 710 is processing a current frame image. In some embodiments, the queuing system may be a lossy queue. For example, the queue of the queuing system may have a length of one frame. Thus, if a new incoming frame image arrives for processing while there is already a frame image waiting in the queue, the frame image waiting in the queue is dropped and the new incoming frame image takes its place in the queue. Whenever computer vision core 710 finishes processing the frame image in the frame image queue, the computation result is then cached by landmarking service layer 708. When computer vision core 710 finishes processing a given frame image that it had retrieved from the frame image queue, the result of the processing itself may be cached by landmarking service 708 in a computation cache. For example, landmarking service 708 may be configured to, when a new frame image arrives, put the incoming frame image into the queue.

In this embodiment, the implementation of the findBoundingPolygon function exposed by landmarking service layer 708 places frame images received from a higher layer into the frame image queue for retrieval for processing by computer vision core 710, but also collects the contents of the computation cache into which the computer vision core 710 has placed prior computation results and returns the contents to the higher layer that called the findBoundingPolygon function of the landmarking service layer 708. It will be appreciated that the contents collected by findBoundingPolygon from the computation cache while placing an incoming frame image into the frame image cache will be in respect of different frame image—and earlie-captured one—than that which is being placed by findBoundingPolygon into the frame image queue. That is, findBoundingPolygon for the landmarking service layer 708 does not wait for computer vision core 710 to process the same frame image it is placing into the frame image queue. As such, the computation results returned by findBoundingPolygon will always be a few frames stale compared to the current frame being rendered simultaneously by user interface 702. However, this implementation provides a sufficiently accurate user interface for providing AR landmarking, while ensuring that any blocking of operations due to waiting is not substantial.

Landmarking service client layer 706 is a counterpart executing on the UI thread to the landmarking service layer 708 executing on the computation thread, and is the layer just above landmarking service layer 708. Landmarking service client layer 706 also exposes two functions to higher layers that each may be thought of as mimicking a respective one of those exposed by landmarking service layer 708. That is, landmarking service client layer 706 exposes a setReferenceImage function and a findBoundingPolygon function to higher layers so that the higher layers may call and send and receive data to and from the setReferenceImage and findBoundingPolygon functions of landmarking service client layer 706, which are at least in part relayed by landmarking service client layer 706 to landmarking service layer 708. Landmarking service client layer 706 also establishes the inter-thread communications between the computation thread and the UI thread along with landmarking service layer 708.

Landmarking service client layer 706 receives, from landmarking service layer 708 in response to a call relayed by landmarking service client layer 706 to the findBoundingPolygon function of landmarking service layer 708, the latest bounding polygon data retrieved from the computation cache into which computer vision core 710 places is computational results. Landmarking service client layer 706 also exposes a broadcast controller, that makes available to higher layers a broadcast stream of the bounding polygon results as they arrive from the landmarking service layer 708 via the inter-thread communication channel.

Application logic layer 704 is the layer just above landmarking service client layer 706. In this embodiment, application logic layer 704 implements and exposes a few functions to higher layers (in this embodiment, for example, to UI layer 702). One of the functions exposed is a bounding polygon result broadcast stream, that is a forwarding of the broadcast stream of the bounding polygon results received from the broadcast controller of landmarking service client layer 706. Another of the functions exposed by application logic layer 704 is a setReferenceImage function. In application logic layer 704, the setReferenceImage function receives-from back-end service 608 after having provided back-end service 608 with a current still image-the location data that defines a location within the current still image of a segment of the current still image. In this embodiment, the location data is generated by back-end service 608 based on an identification of a hotspot within the current still image, as described herein. The setReferenceImage function of application logic layer 704, in turn, generates the reference image using the current still image and the location data. This reference image is then provided, by application logic layer 704, to the landmarking service client layer 706 when calling the setReferenceImage function of the landmarking service client layer 706. In this embodiment, application logic layer 704 also downsizes the data of the reference image prior to providing it to the landmarking service client layer 706, thereby to reduce computational burden and increase computational efficiency.

In this embodiment, another function exposed by application logic layer 704 to a higher layer(s) includes a setupCameraFeed function, prepares an imaging system of client computing device 602 to provide to application logic layer 704 an incoming video stream of frame images captured by the imaging system during AR landmarking. Each frame image provided in the incoming video stream is intercepted by application logic layer 704 once an AR landmarking session is started. Application logic layer 704 also exposes a startLandmarking function, which enables higher layers to trigger application logic layer 704 to relay frame images in the incoming video stream—i.e. a camera feed—to the findBoundingPolygon function exposed by the landmarking service client layer 706. In some embodiments, when the camera feed starts, each camera frame image is downsized in a manner similar to that by which the reference image had downsized, again in order to reduce burden on the processing structure and otherwise to improve computation efficiency.

In addition to downsizing of frame images, the frame images may be cropped. Such cropping may be performed when the physical artifact—such as a piece of artwork—has a different aspect ratio than the aspect ratio of the frame image. The amount of cropping may be calculated as a percentage of the overall frame image dimensions, and the percentage result is stored. Storage of the percentage allows for later post-processing, once the bounding polygon results are received from the broadcasting stream. In particular, the bounding polygon coordinates can accordingly be adjusted to compensate for the percentage of cropping that was performed at the outset to the frame images.

In this embodiment, another function exposed by application logic layer 704 includes a stopLandmarkingSession function that stops sending of the camera feed images to the findBoundingPolygon function exposed by the landmarking service client layer 706 and accordingly stops making calls to functions in lower layers thereby ultimately to, at least until the startLandmarkingSession function is invoked again, stop image processing by computer vision core 710.

UI layer 702 is the layer just above application logic layer 704, and is the only layer visible/accessible to end users. UI layer 702 may present, on a user interface of the computing device 602—for example a touch screen display of a mobile device—a collection of one or more overlays and one or more user interface elements, such as software buttons, that can be interacted with by the end user. For example, an overlay may be a graphical indicator such as a bounding polygon, for example a bounding box, that is generated as described herein during the AR landmarking session for a plurality of image frames and displayed frame after frame thereby to appear to be a single bounding polygon that both persists on the display along with successive frame images being captured and displayed, and tracks on the display the identified hotspot in the frame images. To achieve this, UI layer 702, in this embodiment, consumes the bounding polygon result broadcast stream provided by application logic layer 704.

In this embodiment, the locations and sizes of the bounding polygons flowing out of the broadcasting stream are post-processed by UI layer 702 with exponential moving average smoothing using locations and sizes of bounding polygons flowing just previously from the broadcasting stream. The objective of this smoothing is to reduce the visual jittering of the bounding polygons being displayed, thereby to provide the visual impression of a single bounding polygon persisting across frame images and moving relatively gently as the user moves the computing device with respect to the region of interest, instead of as a series of different bounding polygons being displayed in different places with each frame image, or as a bounding polygon that rapidly darts about. The normalized bounding polygon location may be converted to absolute locations using the size of the rendering canvas provided by the operating system of client computing device 602 on top of which application front-end component 606 itself runs. In some embodiments, buttons presented by UI layer 702 are configured to trigger the startLandmarkingSession and endLandmarkingSession functions exposed by application logic layer 70, to allow a user to control whether and when AR landmarking assistance is provided.

### Distinguishing Between an Overall Capture and a Hotspot Capture.

In some embodiments, one or more layers of application front-end component 606 are configured to distinguish between an overall capture and a hotspot capture. In this description, an overall capture is a still image capture of the entirety of the physical artifact. A hotspot capture, in contrast, is capture of just a segment of the entire physical artifact that is identified by back-end service 608 based on an identification of the hotspot within a current still image. Distinguishing between an overall capture and a hotspot capture can be important for the operation and accuracy of the AR landmarking functionality. This is because the dimensions of the hotspot captures are controlled by back-end service 608, such that the aspect ratios of the hotspot captures are known and fixed across all physical artifacts that may be imaged using computing device 602. For example, in some embodiments, such an aspect ratio may be fixed at 4:3, corresponding to the native aspect ratio of many camera sensors of imaging systems implemented on mobile computing devices.

However, due to a recognition by the inventors that back-end service 608 will not necessarily have complete control over the aspect ratios of all the physical artifacts in its inventory, it has been determined that the AR landmarking functionality described herein should be configured to handle a special case for an overall capture. More particularly, the reference image has the aspect ratio corresponding to the physical artifact within the region of interest. This is because even if the current still image of the overall capture that is captured through a mobile computing device's camera sensor is in its native 4:3 aspect ratio, it is cropped down to the physical aspect ratio of the physical artwork being captured, before being conveyed to back-end service 608 for analysis to identify and locate the appropriate hotspot.

However, the frame image that is capture as part of the camera feed has the aspect ratio of the native camera sensor, which is 4:3. Therefore, if a frame image is obtained by computer vision core 710 for processing to find a bounding polygon, the overlap percentage metric referenced herein would become unreliable, since it would not be capable of perfectly overlapping two images due simply to the aspect ratio differences. As a consequence, therefore, the frame image is cropped down to match the aspect ratio of the reference image before the frame image itself is made available to computer vision core 710 for the bounding polygon search.

Furthermore, when the overlay is generated and displayed along with frame images on the display of the computing device 602 to aid the user with viewfinding, the camera preview viewfinder itself receiving incoming video streams has the aspect ratio of the native camera sensor, which may be 4:3. However, the normalized bounding polygon coordinates are calculated based on the aspect ratio of the physical artifact. Therefore, the bounding polygon cannot be directly drawn on the camera preview viewfinder due to the aspect ratio differences. Rather than drawing the bounding polygon directly, therefore, the bounding polygon's normalized coordinates are remapped from the frame of reference of the reference image with the physical artifacts aspect ratios, into the frame of reference of the viewfinder with the 4:3 aspect ratios. In this way, the bounding polygon displayed in the overlay registers properly with the hotspot in the frame images.

### Waypoint Processing for Extremely Small Segments of the Region of Interest.

AR landmarking may rely as described herein on image processing by the computer vision core 710 to locate the hotspot within the frame image so that a bounding polygon may be generated and displayed. However, it is possible that a given reference image may represent a very small region within a given frame image, such that generating frame image keypoints that can be matched to reference image keypoints can be more difficult to achieve. It will be appreciated that this difficulty can arise in the case of large physical artifacts. For example, a final hotspot capture identified by back-end service 608 may be about the size of the palm of a person's hand, while in order to capture the entire artwork for an overall image, users may need to stand a few meters away from the physical artifact. In this description, two mechanisms may be deployed to address this type of scenario. These are: AR Waypoint and Hotspot Interpolation. It should be noted that these mechanisms only apply to landmarking a final hotspot that is too small to be located within a frame image captured from a faraway distance from the physical artifact.

The AR Waypoint mechanism is for progressively guiding users closer and closer to the final small physical artifact through an intermediate waypoint. The intermediate waypoint may be defined as a capture that is captured between the overall capture and the final hotspot capture. The inventors have found that an intermediate waypoint capture should be sufficiently large such that (a) when used as a reference image, the intermediate waypoint capture can be easily located when using the frame image capturing the overall physical artifact, and (b) when used as a frame image, the final hotspot capture should be sufficiently large so it can be landmarked inside the frame image.

In some embodiments, two set of AR subsystems may be executed in parallel, with a first of the AR subsystems, AR1, using the intermediate waypoint capture as the reference image, and a second of the AR subsystems, AR2, using the final hotspot capture as reference image. This system of AR systems operates by running AR1 and AR2 concurrently.

For example, in some embodiments, AR2 may be used to guide users to the location of the final hotspot. However, when AR2 fails to locate the bounding polygon, the landmarking result of AR1 may be used to guide the user closer to the intermediate waypoint. Once the landmarking result of AR2 is available as users get closer to the intermediate waypoint, AR2 should be able to capture the landmarking result. Then, once AR2 is returning a bounding polygon result, the system may switch over from AR1 to AR2. In certain scenarios, these AR subsystems may be turned off to reduce computation capacity load and energy consumption. For example, should AR2 be returning a steady stream of landmarking polygons, AR1 can be turned off, since the intermediate waypoint is not required.

In some embodiments, a Hotspot Interpolation mechanism may be used as an alternative to the AR Waypoint mechanism described above. The Hotspot Interpolation mechanism may be thought of as replacing the AR1 component in the AR Waypoint mechanism with a different AR landmarking. That is, such a replacement AR1 may operate by using the overall capture as a reference image. However, instead of displaying the landmarking result from the AR1, an additional computation step may be conducted. For example, since the location of the immediate subsequent hotspot capture (“Hotspot 1”) is known within the frame of reference of the overall capture, the Hotspot 1 can be effectively rendered using the landmarking result from the overall capture. It follows that the subsequent hotspot capture's (“Hotspot 2”) location may be known within the frame of reference of Hotspot 1 from back-end service 608, such that Hotspot 2 can be effectively rendered using the landmarking result from Hotspot 1. Since Hotspot 1 can be rendered from the landmarking result from overall capture, this means Hotspot 2 can be rendered from the landmarking result from overall capture. It therefore follows that a final hotspot capture is rendered from the overall capture's landmarking result. Therefore, the AR1 can be replaced from AR Waypoint system, with this augmented AR landmarking. This will use overall capture as the reference image and will compute the final hotspot capture location using the step described above. In some embodiments, the same AR subsystem switching behavior may be reused from the AR Waypoint mechanism.

FIG. 8 is a schematic diagram showing a hardware architecture of a computing system 1000. Computing system 1000 is suitable as the hardware platform for the computing device such as a smartphone having an image capture device, or any of the server(s) that, in embodiments, process captured digital images.

A particular computing system 1000 may be specially configured with software applications and hardware components to enable the capturing, edit, processing, and display of digital media such as digital images, as well as to encode, decode and/or transcode the digital media according to various selected parameters, thereby to compress, decompress, view and/or manipulate the digital media as desired.

Computing system 1000 includes a bus 1010 or other communication mechanism for communicating information, and a processor 1018 coupled with the bus 1010 for processing the information. The computing system 1000 also includes a main memory 1004, such as a random access memory (RAM) or other dynamic storage device (e.g., dynamic RAM (DRAM), static RAM (SRAM), and synchronous DRAM (SDRAM)), coupled to the bus 1010 for storing information and instructions to be executed by processor 1018. In addition, the main memory 1004 may be used for storing temporary variables or other intermediate information during the execution of instructions by the processor 1018. Processor 1018 may include memory structures such as registers for storing such temporary variables or other intermediate information during execution of instructions. The computing system 1000 further includes a read only memory (ROM) 1006 or other static storage device (e.g., programmable ROM (PROM), erasable PROM (EPROM), and electrically erasable PROM (EEPROM)) coupled to the bus 1010 for storing static information and instructions for the processor 1018.

Computing system 1000 also includes a disk controller 1008 coupled to the bus 1010 to control one or more storage devices for storing information and instructions, such as a magnetic hard disk 1022 and/or a solid state drive (SSD) and/or a flash drive, and a removable media drive 1024 (e.g., solid state drive such as USB key or external hard drive, floppy disk drive, read-only compact disc drive, read/write compact disc drive, compact disc jukebox, tape drive, and removable magneto-optical drive). The storage devices may be added to the computing system 1000 using an appropriate device interface (e.g., Serial ATA (SATA), peripheral component interconnect (PCI), small computing system interface (SCSI), integrated device electronics (IDE), enhanced-IDE (E-IDE), direct memory access (DMA), ultra-DMA, as well as cloud-based device interfaces).

Computing system 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

Computing system 1000 also includes a display controller 1002 coupled to the bus 1010 to control a display 1012, such as an LED (light emitting diode) screen, organic LED (OLED) screen, liquid crystal display (LCD) screen or some other device suitable for displaying information to a computer user. In embodiments, display controller 1002 incorporates a dedicated graphics-processing unit (GPU) for processing mainly graphics-intensive or other parallel operations. Such operations may include rendering by applying texturing, shading and the like to wireframe objects including polygons such as spheres and cubes thereby to relieve processor 1018 of having to undertake such intensive operations at the expense of overall performance of computing system 1000. The GPU may incorporate dedicated graphics memory for storing data generated during its operations, and includes a frame buffer RAM memory for storing processing results as bitmaps to be used to activate pixels of display 1012. The GPU may be instructed to undertake various operations by applications running on computing system 1000 using a graphics-directed application-programming interface (API) such as OpenGL, Direct3D and the like.

Computing system 1000 includes input devices, such as a keyboard 1014 and a pointing device 1016, for interacting with a computer user and providing information to the processor 1018. The pointing device 1016, for example, may be a mouse, a trackball, or a pointing stick for communicating direction information and command selections to the processor 1018 and for controlling cursor movement on the display 1012. The computing system 1000 may employ a display device that is coupled with an input device, such as a touch screen. Other input devices may be employed, such as those that provide data to the computing system via wires or wirelessly, such as gesture detectors including infrared detectors, gyroscopes, accelerometers, other kinds of input devices such as radar/sonar, front and/or rear cameras, infrared sensors, ultrasonic sensors, LiDAR (Light Detection and Ranging) sensors, and other kinds of sensors.

Computing system 1000 performs a portion or all of the processing steps discussed herein in response to the processor 1018 and/or GPU of display controller 1002 executing one or more sequences of one or more instructions contained in a memory, such as the main memory 1004. Such instructions may be read into the main memory 1004 from another processor readable medium, such as a hard disk 1022 or a removable media drive 1024. One or more processors in a multi-processing arrangement such as computing system 1000 having both a central processing unit and one or more graphics processing unit may also be employed to execute the sequences of instructions contained in main memory 1004 or in dedicated graphics memory of the GPU. In alternative embodiments, hard-wired circuitry may be used in place of or in combination with software instructions.

As stated above, computing system 1000 includes at least one processor readable medium or memory for holding instructions programmed according to the teachings of the invention and for containing data structures, tables, records, or other data described herein. Examples of processor readable media are solid state devices (SSD), flash-based drives, compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of processor readable media, is software for controlling the computing system 1000, for driving a device or devices to perform the functions discussed herein, and for enabling computing system 1000 to interact with a human user (e.g., for controlling mixing of live-streams of audio and video and other media). Such software may include, but is not limited to, device drivers, operating systems, development tools, and applications software. Such processor readable media further includes the computer program product for performing all or a portion (if processing is distributed) of the processing performed discussed herein.

The computer code devices discussed herein may be any interpretable or executable code mechanism, including but not limited to scripts, interpretable programs, dynamic link libraries (DLLs), object-oriented programming (OOP) modules such as classes, and complete executable programs. Moreover, parts of the processing of the present invention may be distributed for better performance, reliability, and/or cost.

A processor readable medium providing instructions to a processor 1018 may take many forms, including but not limited to, non-volatile media, volatile media, and transmission media. Non-volatile media includes, for example, optical, magnetic disks, and magneto-optical disks, such as the hard disk 1022 or the removable media drive 1024. Volatile media includes dynamic memory, such as the main memory 1004. Transmission media includes coaxial cables, copper wire and fiber optics, including the wires that make up the bus 1010. Transmission media also may also take the form of acoustic or light waves, such as those generated during radio wave and infrared data communications using various communications protocols.

Various forms of processor readable media may be involved in carrying out one or more sequences of one or more instructions to processor 1018 for execution. For example, the instructions may initially be carried on a magnetic disk of a remote computer. The remote computer can load the instructions for implementing all or a portion of the present invention remotely into a dynamic memory and send the instructions over a wired or wireless connection using a modem. A modem local to the computing system 1000 may receive the data via wired Ethernet or wirelessly via Wi-Fi and place the data on the bus 1010. The bus 1010 carries the data to the main memory 1004, from which the processor 1018 retrieves and executes the instructions. The instructions received by the main memory 1004 may optionally be stored on storage device 1022 or 1024 either before or after execution by processor 1018.

Computing system 1000 also includes a communication interface 1020 coupled to the bus 1010. The communication interface 1020 provides a two-way data communication coupling to a network link that is connected to, for example, a local area network (LAN) 1500, or to another communications network 2000 such as the Internet. For example, the communication interface 1020 may be a network interface card to attach to any packet switched LAN. As another example, the communication interface 1020 may be an asymmetric digital subscriber line (ADSL) card, an integrated services digital network (ISDN) card or a modem to provide a data communication connection to a corresponding type of communications line. Wireless links may also be implemented. In any such implementation, the communication interface 1020 sends and receives electrical, electromagnetic or optical signals that carry digital data streams representing various types of information.

The network link typically provides data communication through one or more networks to other data devices, including without limitation to enable the flow of electronic information. For example, the network link may provide a connection to another computer through a local network 1500 (e.g., a LAN) or through equipment operated by a service provider, which provides communication services through a communications network 2000. The local network 1500 and the communications network 2000 use, for example, electrical, electromagnetic, or optical signals that carry digital data streams, and the associated physical layer (e.g., CAT 5 cable, coaxial cable, optical fiber, etc.). The signals through the various networks and the signals on the network link and through the communication interface 1020, which carry the digital data to and from the computing system 1000, may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different from baseband, by modulating a carrier wave. The computing system 1000 can transmit and receive data, including program code, through the network(s) 1500 and 2000, the network link and the communication interface 1020. Moreover, the network link may provide a connection through a LAN 1500 to a mobile device 1300 such as a personal digital assistant (PDA) laptop computer, or cellular telephone.

Alternative configurations of computing systems may be used to implement the systems and processes described herein. For example, computer vision core 710 may be implemented using a machine learning/neural network core processing structure.

Electronic data stores implemented in the database described herein may be one or more of a table, an array, a database, a structured data file, an XML file, or some other functional data store, such as hard disk 1022 or removable media 1024.

Although embodiments have been described, those of skill in the art will appreciate that variations and modifications may be made without departing from the spirit, scope and purpose of the invention as defined by the appended claims.

For example, whereas, in embodiments described herein, the application logic layer 704 generates the reference image based on the location data received from the back-end service and the current still image, alternatives are possible. As one example, the back-end service may create the reference image based on its identification of the hotspot in the current still image. The back-end service may thereafter transmit the reference image back to the application logic layer 704 for use during calls to the setReferenceImage function in a lower layer. Choosing a particular implementation may benefit from bearing in mind that, when enrolling/creating/onboarding a digital fingerprint of the physical artifact for the first time, the reference image is derived from the current image such that that image data is sent down, or the location data could be used. However, when authenticating/verifying the digital fingerprint after it has been created, a next region is known as part of the digital fingerprint, so the back-end service 608 on server 604 can simply return that image, or a smaller, lower resolution version of it, or some other form of the image that could be used to match against keypoints.

Furthermore, whereas in embodiments the findBoundingPolygon function may be used to determine a bounding polygon that is, in turn, displayed as a bounding polygon graphical indication in the overlay, alternatives for guiding a user based on the processing conducted by the computer vision core 710 are possible. For example, rather than displaying a bounding polygon as the graphical indication, the graphical indication may be generated as a visual instruction for the user to shift the field of view of the imaging device closer/farther/up/left/down/right, and/or rotate clockwise or counterclockwise. As such, the graphical indication may be arrows that show a direction in which the user should move the field of view.

Furthermore, as an alternative to a graphical indication, other forms of guidance may be provided to the user, such as audible instructions to shift the field of view of the imaging device closer/farther/up/left/down/right, and/or rotate clockwise or counterclockwise.

While a threshold amount of content correlation between a reference image and a frame image, and in particular percentage of overlap, is used, in embodiments, to determine the degree to which a hotspot is within a frame image, alternatives for making this determination are possible. For example, what may be regarded as an unthresholded approach could be conducted that, instead of considering image overlap, considers whether other non-visual dimensions match thereby to determine other forms of “information correlation” than content correlation. A neural network implementation may be provided that uses the experience/training of a neural network to make its own judgement as to whether there is matching, that would not be considered a “threshold” judgement in the sense of there being a single objective threshold level applicable uniformly across all judgements, nor a single objective comparator (such as visible image content in the case of content correlation).

While, in embodiments, information about the physical artifact within the region of interest is gathered using digital images, and the digital images are processed to identify hotspots based on optical data, alternatives are possible. For example, rather than capturing still digital images and digital video containing frame images, alternative modes of information capture may be used, and data obtained from such alternative modes of information capture may be used to aid a user with “tuning in” to the segment of the region of interest determined to be containing an informational (i.e., not necessarily just a visual) hotspot useful for establishing or authenticating against a digital fingerprint. Such alternative modes of information capture may be used in lieu of, or in combination with, optical image capture. For example, such alternative modes may or may not consider informational content about a physical artifact within the region of interest in the same manner as would optical data. Such alternative modes may include various implementations and uses of LiDAR (Light Detection and Ranging), XRF (X-ray fluorescence), RFID (radio frequency identification), and NFC (near field communications).

Furthermore, the process of creating a unique digital fingerprint may be used for the creation or maintenance of non-fungible tokens (NFTs), registries, registrations, or the like, that uniquely represent physical artifacts or that uniquely represent sub-sections, a fractionalized region or regions, or areas of physical artifacts. For example, a unique digital fingerprint generated as described herein could be encapsulated as an NFT or in association with an NFT, and used as a token for trading in, for example, an online marketplace.

It will be appreciated that the processes described herein enable the creation of a unique digital fingerprint of a physical artifact in a manner that facilitates reliable and validation of the physical artifact. Such validation may be done by a different person each time using the processes described herein, facilitating the reliable authentication of physical artifacts without requiring a human expert or system of experts to do so. In this way, transacting (i.e., buying, selling, transferring ownership, receiving, shipping, transporting, loaning, registering viewing of, checking-in, and other forms of transacting) unique physical artifacts can be done without requiring human intermediaries, facilitating transacting with confidence and at lower cost, and of unique physical artifacts of various values.

It will be appreciated that an expert human authenticator is required to marshal his or her memory of having seen the physical artifact before, or to have an understanding of other physical artifacts made by the same creator, in order to authenticate a physical artifact in any subsequent instance. Human memory is fallible, and an expert human authenticator may no longer be available or may not be available at a time when authentication is desired. Furthermore, an expert human authenticator is not necessarily able to objectively track how close or far a loupe is from a given physical artifact, so is not able to convey to anyone else an amount of detail being registered with a given glance through a loupe.

The processes described herein enable the capture and permanent storage of impartial digital fingerprint data that can be accessed from any remote location, as it may be made available in a public database such as a block chain or a more centralized database.

It will be appreciated that the processes described herein may be used in conjunction with current owner, location, and transaction information tracking in connection with a particular physical artifact. In this way, subsequent—or secondary market—transactions can be registered so that, if desired, an original creator of the physical artifact or another designated party, may be compensated for transactions happening subsequent to an initial sale.

It will be appreciated that validations can be conducted at the time of a transaction, to ratify the transaction, and/or may be conducted between transactions in order to secure modified digital fingerprint information as the physical artifact itself evolves. This may also be done in order to confirm a current owner and/or location in case an original creator or other designated party wishes to keep track of this information. For example, an artist or other designated party may wish to keep track of the current location and current owner of an original painting. Furthermore, such interim validations may be useful for leveraging improvements in image capture technologies for capturing more and more information about a given physical artifact.

While embodiments described herein are applicable to two-dimensioned physical artifacts such as paintings and drawings, embodiments are also applicable to three-dimensional physical artifacts such as sculptures. In order to create a unique digital fingerprint of a three-dimensional physical artifact, images captured of a physical artifact may be mapped to 3D space using multiple frames in succession. The iterative image capture process could then occur while information about the surface of the physical artifact or the perspective in 3D space in respect of the physical artifact is associated with the given captured digital image.

It will be appreciated that the processes described herein obviate the requirement for a separate physical appendage such as a QR code or hologram to be placed on—or otherwise associated with-the physical artifact, in order to validate the physical artifact as unique.

It will be appreciated that, while embodiments herein include capture and processing of digital images, in other embodiments sensors other than image capture sensors may be used to capture features of a physical artifact in a region of interest, such as features discernable through physical contact by sensors with the physical artifact, and/or features discernable through physical reflection of light and/or radiofrequency waves, or other reflective phenomena. Such sensors other than image capture sensors may produce data indicative of the physical features discerned by touch, reflection of light and/or radiofrequency waves or other reflective phenomena, with such data having sufficient richness for enabling processes such as those described herein to discern features and/or clusters of features. Such sensors other than image capture sensor, and the captured data, may be used instead of, or in conjunction with, data from one or more image capture devices as described herein.

While embodiments have been described with particular pixel dimensions, this has been done for illustrative purposes. Implementations using other pixel dimensions are possible.

### CLAUSES

Clause 1. A method comprising:
(a) capturing, by an imaging system of a computing device, a current still image of a region of interest;
(b) receiving, at the computing device, location data that defines a location within the current still image of a segment of the current still image, the location data generated based on an identification of a hotspot within the current still image;
(c) generating, by the computing device based at least on the location data and the current still image, a reference image corresponding to the segment;
(d) capturing, by the imaging system of the computing device, an incoming video stream containing frame images; and
(e) during the capturing of the incoming video stream:
displaying, by the computing device on a display screen, the frame images of the incoming video stream; and
for each frame image of a plurality of the frame images of the incoming video stream:
responsive to a determination, by the computing device, that a portion of the frame image has at least a threshold amount of content correlation with the reference image, generating, by the computing device, a graphical indication demarcating the portion of the frame image; and
displaying, by the computing device on the display screen with the frame images of the incoming video stream being displayed, an overlay containing the graphical indication.

Clause 2. The method of clause 1, wherein step (e) comprises:
for each frame image of a plurality of the frame images of the incoming video stream:
responsive to a determination, by the computing device, that no portion of the frame image has at least the threshold amount of content correlation with the reference image, displaying, by the computing device with the frame images of the incoming video stream, the overlay without the graphical indication.

Clause 3. The method of clause 1, wherein step (e) comprises:
responsive to the determination, by the computing device, that the portion of the frame image has at least the threshold amount of content correlation with the reference image and a further determination that the portion is at least a threshold proportion of the frame image, at least one of:
automatically capturing, by the imaging system of a computing device, a next still image of the region of interest; and
instructing a user of the computing device to cause the imaging system of the computing device to capture the next still image of the region of interest.

Clause 4. The method of clause 3, wherein instructing the user of the computing device to cause the imaging system of the computing device to capture the next still image of the region of interest comprises changing a visible characteristic of the graphical indication demarcating the portion of the frame image.

Clause 5. The method of clause 3, comprising:
responsive to a capture of the next still image, conducting (b), (c), (d), and (e) with the next still image as the current still image.

Clause 6. The method of clause 1, comprising:
processing the reference image to extract reference image keypoints;
   wherein the determination, by the computing device, that the portion of the frame image has at least the threshold amount of content correlation with the reference image comprises:
processing the frame image to extract frame image keypoints;
determining one or more matches between the reference image keypoints and the frame image keypoints;
generating a mapping of the reference image to the frame image based at least on the one or more matches;
calculating an amount of overlap between the reference image and the frame image based on the mapping; and
determining that the amount of overlap meets or exceeds a threshold amount of overlap.

Clause 7. A system, comprising:
a computing device having an imaging system and executing a front-end component of an application, the front-end component of the application being in communication with a back-end component of the application executing on a server, the front-end component of the application configured to:
(a) cause capture, by the imaging system, of a current still image of a region of interest;
(b) receive, from the back-end component, location data that defines a location within the current still image of a segment of the current still image, the location data generated by the back-end component based on an identification of a hotspot within the current still image;
(c) generate, based at least on the location data and the current still image, a reference image corresponding to the segment;
(d) cause capture, by the imaging system, of an incoming video stream containing frame images; and
(e) during the capture of the incoming video stream:
display, on a display screen of the computing device, the frame images of the incoming video stream; and
for each frame image of a plurality of the frame images of the incoming video stream:
responsive to a determination that a portion of the frame image has at least a threshold amount of content correlation with the reference image, generate a graphical indication demarcating the portion of the frame image; and
display, on the display screen with the frame images of the incoming video stream being displayed, an overlay containing the graphical indication.

Clause 8. The system of clause 7, wherein the front-end component is configured to, during (e):
for each frame image of a plurality of the frame images of the incoming video stream:
responsive to a determination that no portion of the frame image has at least the threshold amount of content correlation with the reference image, display, by the computing device with the frame images of the incoming video stream, the overlay without the graphical indication.

Clause 9. The system of clause 7, wherein the front-end component is configured to, during (e):
responsive to the determination, that the portion of the frame image has at least the threshold amount of content correlation with the reference image and a further determination that the portion is at least a threshold proportion of the frame image, at least one of:
automatically capture, by the imaging system, a next still image of the region of interest; and
instruct a user of the computing device to cause the imaging system of the computing device to capture the next still image of the region of interest.

Clause 10. The method of clause 7, wherein the front-end component is configured to instruct the user of the computing device to cause the imaging system of the computing device to capture the next still image of the region of interest by changing a visible characteristic of the graphical indication demarcating the portion of the frame image.

Clause 11. The system of clause 9, wherein the front-end component is configured to:
responsive to a capture of the next still image, conducting (b), (c), (d), and (e) with the next still image as the current still image.

Clause 12. The system of clause 7, wherein the front-end component is configured to:
process the reference image to extract reference image keypoints;
   wherein to determine that the portion of the frame image has at least the threshold amount of content correlation with the reference image, the front-end component is configured to:
process the frame image to extract frame image keypoints;
determine one or more matches between the reference image keypoints and the frame image keypoints;
generate a mapping of the reference image to the frame image based at least on the one or more matches;
calculate an amount of overlap between the reference image and the frame image based on the mapping; and
determine that the amount of overlap meets or exceeds a threshold amount of overlap.

Clause 13. A non-transitory computer readable medium embodying a computer program executable on a computing device, the computer program comprising computer program code for:
(a) causing capturing, by an imaging system of a computing device, a current still image of a region of interest;
(b) receiving location data that defines a location within the current still image of a segment of the current still image, the location data generated based on an identification of a hotspot within the current still image;
(c) generating, based at least on the location data and the current still image, a reference image corresponding to the segment;
(d) causing capturing, by the imaging system, an incoming video stream containing frame images; and
(e) during the capturing of the incoming video stream:
displaying, on a display screen of the computing device, the frame images of the incoming video stream; and
for each frame image of a plurality of the frame images of the incoming video stream:
responsive to a determination that a portion of the frame image has at least a threshold amount of content correlation with the reference image, generating a graphical indication demarcating the portion of the frame image; and
displaying, on the display screen with the frame images of the incoming video stream being displayed, an overlay containing the graphical indication.

Clause 14. The non-transitory computer readable medium of clause 13, the computer program comprising computer program code for, during (e):
for each frame image of a plurality of the frame images of the incoming video stream:
responsive to a determination that no portion of the frame image has at least the threshold amount of content correlation with the reference image, displaying, with the frame images of the incoming video stream, the overlay without the graphical indication.

Clause 15. The non-transitory computer readable medium of clause 13, the computer program comprising computer program code for, during (e):
responsive to the determination that the portion of the frame image has at least the threshold amount of content correlation with the reference image and a further determination that the portion is at least a threshold proportion of the frame image, at least one of:
automatically capturing, by the imaging system, a next still image of the region of interest; and
instructing a user of the computing device to cause the imaging system of the computing device to capture the next still image of the region of interest.

Clause 16. The non-transitory computer readable medium of clause 13, wherein the computer code for instructing the user of the computing device to cause the imaging system of the computing device to capture the next still image of the region of interest comprises computer program code for changing a visible characteristic of the graphical indication demarcating the portion of the frame image.

Clause 17. The non-transitory computer readable medium of clause 15, the computer program comprising computer program code for:
responsive to a capture of the next still image, conducting (b), (c), (d), and (e) with the next still image as the current still image.

Clause 18. The non-transitory computer readable medium of clause 13, the computer program comprising computer program code for:
processing the reference image to extract reference image keypoints;
   wherein to conduct the determination that the portion of the frame image has at least the threshold amount of content correlation with the reference image, the computer program comprises computer program code for:
processing the frame image to extract frame image keypoints;
determining one or more matches between the reference image keypoints and the frame image keypoints;
generating a mapping of the reference image to the frame image based at least on the one or more matches;
calculating an amount of overlap between the reference image and the frame image based on the mapping; and
determining that the amount of overlap meets or exceeds a threshold amount of overlap.

What is claimed is:

1. A method comprising:
(a) capturing, by an imaging system of a computing device, a current still image of a region of interest;
(b) receiving, at the computing device, location data that defines a location within the current still image of a segment of the current still image, the location data generated based on an identification of a hotspot within the current still image;
(c) generating, by the computing device based at least on the location data and the current still image, a reference image corresponding to the segment;
(d) capturing, by the imaging system of the computing device, an incoming video stream containing frame images; and
(e) during the capturing of the incoming video stream:
displaying, by the computing device on a display screen, the frame images of the incoming video stream; and
for each frame image of a plurality of the frame images of the incoming video stream:
responsive to a determination, by the computing device, that a portion of the frame image has at least a threshold amount of content correlation with the reference image, generating, by the computing device, a graphical indication demarcating the portion of the frame image; and
displaying, by the computing device on the display screen with the frame images of the incoming video stream being displayed, an overlay containing the graphical indication.

2. The method of claim 1, wherein step (e) comprises:
for each frame image of a plurality of the frame images of the incoming video stream:
responsive to a determination, by the computing device, that no portion of the frame image has at least the threshold amount of content correlation with the reference image, displaying, by the computing device with the frame images of the incoming video stream, the overlay without the graphical indication.

3. The method of claim 1, wherein step (e) comprises:
responsive to the determination, by the computing device, that the portion of the frame image has at least the threshold amount of content correlation with the reference image and a further determination that the portion is at least a threshold proportion of the frame image, at least one of:
automatically capturing, by the imaging system of a computing device, a next still image of the region of interest; and
instructing a user of the computing device to cause the imaging system of the computing device to capture the next still image of the region of interest.

4. The method of claim 3, wherein instructing the user of the computing device to cause the imaging system of the computing device to capture the next still image of the region of interest comprises changing a visible characteristic of the graphical indication demarcating the portion of the frame image.

5. The method of claim 3, comprising:
responsive to a capture of the next still image, conducting (b), (c), (d), and (e) with the next still image as the current still image.

6. The method of claim 1, comprising:
processing the reference image to extract reference image keypoints;
wherein the determination, by the computing device, that the portion of the frame image has at least the threshold amount of content correlation with the reference image comprises:
processing the frame image to extract frame image keypoints;
determining one or more matches between the reference image keypoints and the frame image keypoints;
generating a mapping of the reference image to the frame image based at least on the one or more matches;
calculating an amount of overlap between the reference image and the frame image based on the mapping; and
determining that the amount of overlap meets or exceeds a threshold amount of overlap.

7. A system, comprising:
a computing device having an imaging system and executing a front-end component of an application, the front-end component of the application being in communication with a back-end component of the application executing on a server, the front-end component of the application configured to:
(a) cause capture, by the imaging system, of a current still image of a region of interest;
(b) receive, from the back-end component, location data that defines a location within the current still image of a segment of the current still image, the location data generated by the back-end component based on an identification of a hotspot within the current still image;
(c) generate, based at least on the location data and the current still image, a reference image corresponding to the segment;
(d) cause capture, by the imaging system, of an incoming video stream containing frame images; and
(e) during the capture of the incoming video stream:
display, on a display screen of the computing device, the frame images of the incoming video stream; and
for each frame image of a plurality of the frame images of the incoming video stream:
responsive to a determination that a portion of the frame image has at least a threshold amount of content correlation with the reference image, generate a graphical indication demarcating the portion of the frame image; and
display, on the display screen with the frame images of the incoming video stream being displayed, an overlay containing the graphical indication.

8. The system of claim 7, wherein the front-end component is configured to, during (e):
for each frame image of a plurality of the frame images of the incoming video stream:
responsive to a determination that no portion of the frame image has at least the threshold amount of content correlation with the reference image, display, by the computing device with the frame images of the incoming video stream, the overlay without the graphical indication.

9. The system of claim 7, wherein the front-end component is configured to, during (e):
responsive to the determination, that the portion of the frame image has at least the threshold amount of content correlation with the reference image and a further determination that the portion is at least a threshold proportion of the frame image, at least one of:
automatically capture, by the imaging system, a next still image of the region of interest; and
instruct a user of the computing device to cause the imaging system of the computing device to capture the next still image of the region of interest.

10. The method of claim 7, wherein the front-end component is configured to instruct the user of the computing device to cause the imaging system of the computing device to capture the next still image of the region of interest by changing a visible characteristic of the graphical indication demarcating the portion of the frame image.

11. The system of claim 9, wherein the front-end component is configured to:
responsive to a capture of the next still image, conducting (b), (c), (d), and (e) with the next still image as the current still image.

12. The system of claim 7, wherein the front-end component is configured to:
process the reference image to extract reference image keypoints;
wherein to determine that the portion of the frame image has at least the threshold amount of content correlation with the reference image, the front-end component is configured to:
process the frame image to extract frame image keypoints;
determine one or more matches between the reference image keypoints and the frame image keypoints;
generate a mapping of the reference image to the frame image based at least on the one or more matches;
calculate an amount of overlap between the reference image and the frame image based on the mapping; and
determine that the amount of overlap meets or exceeds a threshold amount of overlap.

13. A non-transitory computer readable medium embodying a computer program executable on a computing device, the computer program comprising computer program code for:
(a) causing capturing, by an imaging system of a computing device, a current still image of a region of interest;
(b) receiving location data that defines a location within the current still image of a segment of the current still image, the location data generated based on an identification of a hotspot within the current still image;
(c) generating, based at least on the location data and the current still image, a reference image corresponding to the segment;
(d) causing capturing, by the imaging system, an incoming video stream containing frame images; and
(e) during the capturing of the incoming video stream:
displaying, on a display screen of the computing device, the frame images of the incoming video stream; and
for each frame image of a plurality of the frame images of the incoming video stream:
responsive to a determination that a portion of the frame image has at least a threshold amount of content correlation with the reference image, generating a graphical indication demarcating the portion of the frame image; and
displaying, on the display screen with the frame images of the incoming video stream being displayed, an overlay containing the graphical indication.

14. The non-transitory computer readable medium of claim 13, the computer program comprising computer program code for, during (e):
for each frame image of a plurality of the frame images of the incoming video stream:
responsive to a determination that no portion of the frame image has at least the threshold amount of content correlation with the reference image, displaying, with the frame images of the incoming video stream, the overlay without the graphical indication.

15. The non-transitory computer readable medium of claim 13, the computer program comprising computer program code for, during (e):
responsive to the determination that the portion of the frame image has at least the threshold amount of content correlation with the reference image and a further determination that the portion is at least a threshold proportion of the frame image, at least one of:
automatically capturing, by the imaging system, a next still image of the region of interest; and
instructing a user of the computing device to cause the imaging system of the computing device to capture the next still image of the region of interest.

16. The non-transitory computer readable medium of claim 13, wherein the computer code for instructing the user of the computing device to cause the imaging system of the computing device to capture the next still image of the region of interest comprises computer program code for changing a visible characteristic of the graphical indication demarcating the portion of the frame image.

17. The non-transitory computer readable medium of claim 15, the computer program comprising computer program code for:
responsive to a capture of the next still image, conducting (b), (c), (d), and (e) with the next still image as the current still image.

18. The non-transitory computer readable medium of claim 13, the computer program comprising computer program code for:
processing the reference image to extract reference image keypoints;
wherein to conduct the determination that the portion of the frame image has at least the threshold amount of content correlation with the reference image, the computer program comprises computer program code for:
processing the frame image to extract frame image keypoints;
determining one or more matches between the reference image keypoints and the frame image keypoints;
generating a mapping of the reference image to the frame image based at least on the one or more matches;
calculating an amount of overlap between the reference image and the frame image based on the mapping; and
determining that the amount of overlap meets or exceeds a threshold amount of overlap.
